(19) United States
(12) Patent Application Publication
(10) Pub. No.: US 2026/0223022 A1
(43) Pub. Date: Jul. 30, 2026

(54) APPARATUS AND METHOD FOR PERFORMING SUBARRAY-BASED INITIAL ACCESS IN WIRELESS COMMUNICATION SYSTEM

(71) Applicants: LG ELECTRONICS INC., Seoul (KR); KOREA ADVANCED INSTITUTE OF SCIENCE AND TECHNOLOGY, Daejeon (KR)

(72) Inventors: Jaehoon CHUNG, Seoul (KR); Seung Won KEUM, Daejeon (KR); Dang-Oh KIM, Daejeon (KR); Dong-Ho CHO, Daejeon (KR); Ju Yong LEE, Daejeon (KR); Sang Min OH, Daejeon (KR)

(73) Assignees: LG ELECTRONICS INC., Seoul (KR); KOREA ADVANCED INSTITUTE OF SCIENCE AND TECHNOLOGY, Daejeon (KR)

(21) Appl. No.: 19/143,338

(22) PCT Filed: Dec. 26, 2022
(86) PCT No.: PCT/KR2022/021323

§ 371 Date: Jun. 25, 2025

(51) Int. Cl. H04W 56/00; H04B 7/06; H04L 5/00; H04W 74/0833; H04W 76/20

(52) U.S. Cl. CPC H04W 56/0015; H04B 7/06968; H04L 5/0051; H04W 74/0833; H04W 76/20

(57) ABSTRACT

The present disclosure is to perform a subarray-based initial access in a wireless communication system. An operation method of a user equipment (UE) may comprise the steps of: receiving at least one synchronization signal block (SSB) among SSBs transmitted by a base station; receiving system information transmitted by the base station; transmitting a random access preamble on the basis of the system information; receiving a random access response (RAR) message on the basis of information related to the random access preamble; and performing signaling for establishing a radio resource control (RRC) connection. The random access preamble may include information related to a channel estimated using reference signals received along with the SSB and the system information.

### CROSS-REFERENCE TO RELATED APPLICATION(S)

This application is the National Stage filing under 35 U.S.C. 371 of International Application No. PCT/KR2022/021323, filed on Dec. 26, 2022, the contents of which are all incorporated by reference herein in its entirety.

### TECHNICAL FIELD

The following description is directed to a wireless communication system, and is directed to a device and method for performing subarray-based initial access in a wireless communication system.

### BACKGROUND

Wireless communication systems have been widely deployed to provide various types of communication services including voice and data services. In general, a wireless communication system is a multiple access system that supports communication among multiple users by sharing available system resources (e.g. bandwidth, transmit power, etc.) among the multiple users. The multiple access system may adopt a multiple access scheme such as code division multiple access (CDMA), frequency division multiple access (FDMA), time division multiple access (TDMA), orthogonal frequency division multiple access (OFDMA), or single carrier frequency division multiple access (SC-FDMA).

Especially, as many communication devices have demanded large communication capacity, enhanced mobile broadband (eMBB) communication technology has been proposed compared to conventional radio access technology (RAT). In addition, communication systems that consider reliability and latency sensitive services/user equipment (UE) as well as massive machine type communications (mMTC) that connect multiple devices and objects to provide various services anytime, anywhere are being proposed. Various technical configurations have been proposed for this purpose.

### SUMMARY

The present disclosure may provide methods and device for effectively performing an initial access procedure in a wireless communication system.

The present disclosure may provide methods and device for performing an antenna sub-array based initial access procedure in a wireless communication system.

The present disclosure may provide methods and device for performing an initial access procedure considering a Fresnel zone in a wireless communication system.

The present disclosure may provide methods and device for supporting an initial access procedure using a narrow beam in a wireless communication system.

The present disclosure may provide methods and device for obtaining multiple input multiple output (MIMO) channel information during an initial access procedure in a wireless communication system.

The present disclosure may provide methods and device for allocating an antenna subarray for use in a wireless communication system for an initial access procedure.

The present disclosure may provide methods and device for allocating an antenna subarray for use in a wireless communication system for an initial access procedure.

The present disclosure may provide methods and device for delivering channel-related information using random access preamble in a wireless communication system.

The present disclosure may provide methods and device for reducing the latency required by a wireless communication system to provide signaling or information necessary for initial access.

The present disclosure may provide methods and device for reducing latency for transmitting a synchronization signal block (SSB) in a wireless communication system.

The present disclosure may provide methods and device for transmitting SSBs using multi-beam in a wireless communication system.

The present disclosure may provide methods and device for reducing latency in transmitting system information in a wireless communication system.

The present disclosure may provide methods and device for transmitting system information using multi-beams in a wireless communication system.

The technical objectives of the present disclosure are not limited to those mentioned above, and other technical problems not mentioned may be considered by one of ordinary skill in the art to which the technical configurations of the present disclosure are applied from the embodiments of the present disclosure that will be described below.

According to an embodiment of the present disclosure, an operation method of a user equipment (UE) in wireless communication system may include: receiving at least one synchronization signal block (SSB) among SSBs transmitted by a base station; receiving, system information transmitted by the base station; transmitting a random access preamble based on the system information; receiving a random access response (RAR) message based on information related to the random access preamble; performing signaling for establishing a radio resource control (RRC) connection. The random access preamble may include information related to a channel estimated by using reference signals received along with the SSB and the system information.

According to an embodiment of the present disclosure, an operation method of a base station in wireless communication system may include: transmitting synchronization signal blocks (SSBs) using a plurality of spatial domain filters; transmitting system information; receiving, from a user equipment (UE), a random access preamble; transmitting a random access response (RAR) message based on information related to the random access preamble; performing signaling for establishing a radio resource control (RRC) connection. The random access preamble may include information related to a channel estimated by using reference signals transmitted along with at least one SSB among the SSBs and the system information.

According to an embodiment of the present disclosure, for a user equipment (UE) in wireless communication system, the UE may comprises: a transceiver; and a processor connected to the transceiver, the processor may controls to: receive at least one synchronization signal block (SSB) among SSBs transmitted by a base station; receive, system information transmitted by the base station; transmit a random access preamble based on the system information; receive a random access response (RAR) message based on information related to the random access preamble; perform signaling for establishing a radio resource control (RRC) connection, the random access preamble may include information related to a channel estimated by using reference signals received along with the SSB and the system information.

According to an embodiment of the present disclosure, for base station in wireless communication system, the base station may comprise: a transceiver; and a processor connected to the transceiver, the processor may control to: transmit synchronization signal blocks (SSBs) using a plurality of spatial domain filters; transmit system information; receive, from a user equipment (UE), a random access preamble; transmit a random access response (RAR) message based on information related to the random access preamble; perform signaling for establishing a radio resource control (RRC) connection, the random access preamble may include information related to a channel estimated by using reference signals transmitted along with at least one SSB among the SSBs and the system information.

According to an embodiment of the present disclosure, a communication device may comprise: at least one processor; at least one computer memory connected to the at least one processor, storing instructions that instructs operations according to being operated by the at least one processor, the operations may include: receiving at least one synchronization signal block (SSB) among SSBs transmitted by a base station; receiving, system information transmitted by the base station; transmitting a random access preamble based on the system information; receiving a random access response (RAR) message based on information related to the random access preamble; performing signaling for establishing a radio resource control (RRC) connection, the random access preamble may include information related to a channel estimated by using reference signals received along with the SSB and the system information.

According to an embodiment of the present disclosure, a non-transitory computer-readable medium storing at least one instruction, may comprise: the at least one instruction executable by a processor, the at least one instruction may control a device to: receive at least one synchronization signal block (SSB) among SSBs transmitted by a base station; receive, system information transmitted by the base station; transmit a random access preamble based on the system information; receive a random access response (RAR) message based on information related to the random access preamble; perform signaling for establishing a radio resource control (RRC) connection, the random access preamble may include information related to a channel estimated by using reference signals received along with the SSB and the system information.

The above-described features of the present disclosure are only some of the preferred embodiments of the present disclosure, and various embodiments reflecting the technical features of the present disclosure may be derived and understood by one with ordinary skill in the art based on the detailed description of the present disclosure that follows.

Embodiments based on the present disclosure may have the following effects.

According to the present disclosure, the initial access procedure may be performed effectively.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings. That is, unintended effects of the present disclosure may be also derived by those skilled in the art from the embodiments of the present disclosure.

### BRIEF DESCRIPTION OF THE DRAWINGS

The accompanying drawings are intended to provide a better understanding of the present disclosure and may provide embodiments of the disclosure along with a detailed description. However, the technical features of the present disclosure are not limited to any specific drawing, and the features disclosed in each drawing may be combined with each other to form new embodiments. Reference numerals in each drawing may refer to structural elements.

FIG. 1 shows an example communication system applicable to the present disclosure.

FIG. 2 shows an example of a wireless device applicable to the present disclosure.

FIG. 3 shows another example of a wireless device applicable to the present disclosure.

FIG. 4 shows an example of a mobile device applicable to the present disclosure.

FIG. 5 shows an example of a vehicle or autonomous vehicle applicable to the present disclosure.

FIG. 6 shows an example of artificial intelligence (AI) applicable to the present disclosure.

FIG. 7 shows a method of processing a transmission signal applicable to the present disclosure.

FIG. 8 shows an example of a communication structure that can be provided in a 6th generation (6G) system applicable to the present disclosure.

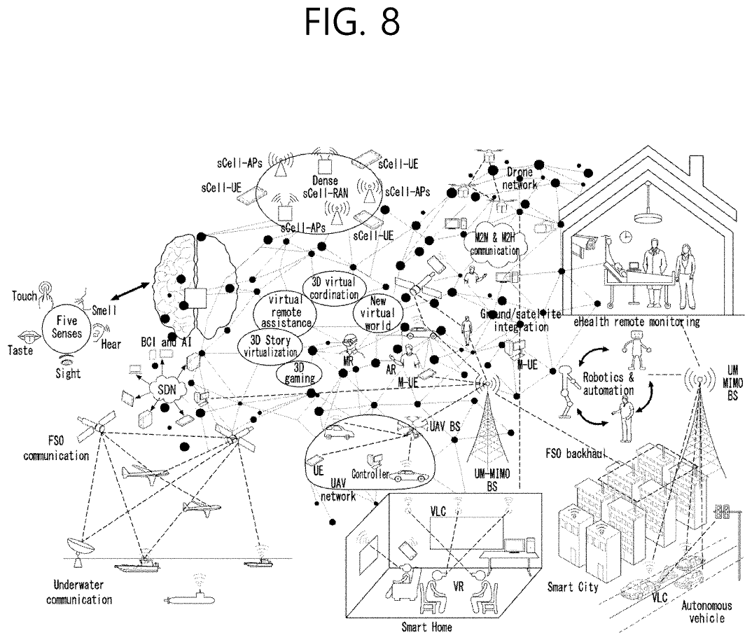

FIG. 9 shows an electromagnetic spectrum applicable to the present disclosure.

FIG. 10 shows a THz communication method applicable to the present disclosure.

FIGS. 11A and 11B show examples of beam sweeping to explore a narrow beam covering a terminal.

FIG. 12a shows an example of synchronization signal block (SSB) transmission via beam sweeping.

FIG. 12b shows an example of the structure of a synchronization signal block (SSB).

FIG. 13 shows an example of an initial access procedure based on SS bursts.

FIG. 14 shows an example of a situation where narrow beams are used.

FIG. 15 shows an example of multiple input multiple output (MIMO) data and MIMO pilot in a narrow beam environment.

FIG. 16 shows an example of a radio frequency (RF) system according to one embodiment of the present disclosure.

FIGS. 17A and 17B show examples of beam sweeping for SS bursts and beam sweeping for system information, according to one embodiment of the present disclosure.

FIG. 17c shows an example of a range of MIMO channel estimates based on subarray allocation, according to one embodiment of the present disclosure.

FIG. 18 shows an example of a multi-beam SSB transmission according to one embodiment of the present disclosure.

FIG. 19 shows an example of a procedure to support initial access according to one embodiment of the present disclosure.

FIG. 20 shows an example of a procedure for performing an initial access in accordance with one embodiment of the present disclosure.

FIG. 21 shows an example of an initial access procedure according to one embodiment of the present disclosure.

FIG. 22 shows an example of a procedure for performing beam sweeping and subarray allocation during an initial access procedure according to one embodiment of the present disclosure.

FIG. 23 shows an example of a procedure for reporting beam information during an initial access procedure according to one embodiment of the present disclosure.

FIG. 24 shows an example of a mapping structure of system information and pilots, according to one embodiment of the present disclosure.

### DETAILED DESCRIPTION

The embodiments of the present disclosure described hereinbelow are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or features of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

Throughout the specification, whenever any part is the to “comprising or including” any component, it is meant to be inclusive of other components, not exclusive of other components, unless specifically stated to the contrary. In addition, terms such as “ . . . part,” “ . . . device,” “module,” and the like in the specification mean a unit that performs at least one function or operation, which may be implemented in hardware or software or a combination of hardware and software. In addition, the terms “a or an,” “one,” “the,” and similar related words may be used in the context of describing this disclosure (especially in the context of the following claims) to include both the singular and the plural, unless otherwise indicated herein or clearly refuted by the context. In the embodiments of the present disclosure, a description is made, centering on a data transmission and reception relationship between a Base Station (BS) and a User Equipment (UE). A BS is a terminal node of a network, which communicates directly with a UE. In some cases, a specific operation described as performed by the BS may be performed by an upper node of the BS.

Namely, it is apparent that, in a network comprised of a plurality of network nodes including a BS, various operations performed for communication with a UE may be performed by the BS or network nodes other than the BS. The term ‘BS’ may be replaced with the term ‘fixed station’, ‘Node B’, ‘evolved Node B (eNode B or eNB)’, Advanced BS (ABS)′, ‘Access Point (AP)’, etc.

In addition, the term ‘terminal’ may be replaced with the term ‘UE’, ‘Mobile Station (MS)’, ‘Subscriber Station (SS)’, ‘Mobile Subscriber Station (MSS)’, ‘Mobile Terminal’, ‘Advanced MS (AMS)’, etc.

A transmission end refers to a fixed and/or mobile node that provides data service or voice service and a reception end refers to a fixed and/or mobile node that receives data service or voice service. Accordingly, a UE may serve as a transmission end and a BS may serve as a reception end, on the uplink, whereas the UE may serve as a reception end and the BS may serve as a transmission end, on the downlink.

The embodiments of the present disclosure can be supported by standard documents disclosed for at least one of wireless access systems, that is, an Institute of Electrical and Electronics Engineers (IEEE) 802.xx system, a 3rd Generation Partnership Project (3GPP) system, a 3GPP Long Term Evolution (LTE) system, and a 3GPP2 system. Especially, the embodiments of the present disclosure can be supported by 3GPP TS 38.211, 3GPP TS 38.212, 3GPP TS 38.213, and 3GPP TS 38.321.

Further, embodiments of the present disclosure may be applicable to other wireless access systems and are not limited to the systems described above. For example, they may be applicable to post-3GPP 5G NR systems, and are not limited to any specific system.

That is, steps or parts that are not described in order to clarify the subject matter of the present disclosure can be supported by the above documents. Further, all terms described in this specification can be explained by the standard documents.

Reference will now be made in detail to the preferred embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

Specific terms used in the embodiments of the present disclosure are used to help the understanding of the present disclosure and they can be replaced with other terms within the spirit and scope of the present disclosure.

The following embodiments of the present disclosure can be applied to a variety of wireless access technologies, for example, CDMA, FDMA, TDMA, OFDMA, SC-FDMA, MC-FDMA, and the like.

For clarity, the following description is based on 3GPP communication systems (e.g., LTE, NR, etc.), but the technical ideas of the present disclosure are not limited thereto. LTE may refer to technology from 3GPP TS 36.xxx Release 8 onwards. More specifically, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology from TS Release 17 and/or Release 18 onwards. “xxx” means standard document detail number. LTE/NR/6G may be referred to collectively as the 3GPP system.

For background descriptions, terms, abbreviations, and the like used in this disclosure, reference is made to standards documents published prior to this disclosure. For example, the 36.xxx and 38.xxx standards documents may be referenced.

### Communication System Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

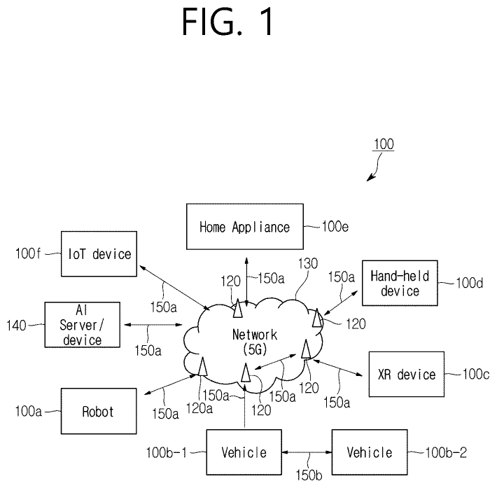

Hereinafter, a description will be given in more detail with reference to the drawings. In the following drawings/description, the same reference symbols may denote the same or corresponding hardware blocks, software blocks, or functional blocks unless described otherwise. FIG. 1 shows a communication system applied to the present disclosure.

Referring to FIG. 1, a communication system 100 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IOT) device 100f, and an Artificial Intelligence (AI) device/server 100g. For example, the vehicles 100b-1, 100b-2 may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device 100d may include a smartphone, a smartpad, a wearable device (e.g., a smartwatch or a smartglasses), and a computer (e.g., a notebook). The home appliance 100e may include a TV, a refrigerator, and a washing machine. The IoT device 100f may include a sensor and a smartmeter. For example, the BSs 120 and the network 130 may be implemented as wireless devices and a specific wireless device 120a may operate as a BS/network node with respect to other wireless devices.

The wireless devices 100a to 100f may be connected to the network 120 via the BSs 120. An AI technology may be applied to the wireless devices 100a to 100f and the wireless devices 100a to 100f may be connected to the AI server 100g via the network 130. The network 130 may be configured using a 3G network, a 4G (e.g., LTE) network, or a 5G (e.g., NR) network. Although the wireless devices 100a to 100f may communicate with each other through the BSs 120/network 130, the wireless devices 100a to 100f may perform direct communication (e.g., sidelink communication) with each other without passing through the BSs 120/network 130. For example, the vehicles 100b-1 and 100b-2 may perform direct communication (e.g. Vehicle-to-Vehicle (V2V)/Vehicle-to-everything (V2X) communication). The IoT device 100f (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 120, or BS 120/BS 120. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Communication System Applicable to the Present Disclosure

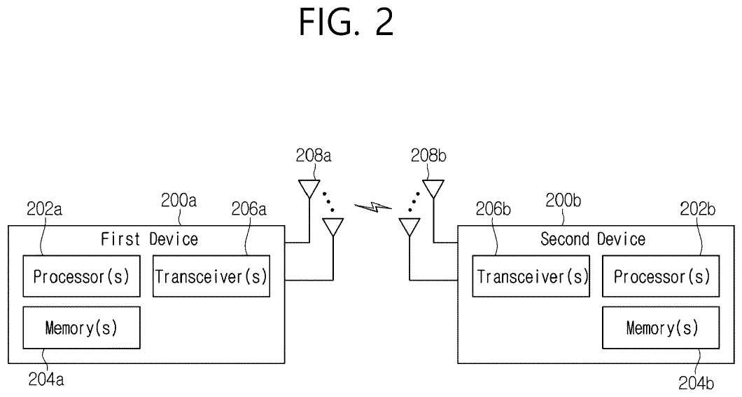

FIG. 2 is a diagram showing an example wireless device that may be applicable to the present disclosure.

Referring to FIG. 2, a first wireless device 200a and a second wireless device 200b may transmit radio signals through a variety of RATs (e.g., LTE and NR). Herein, {the first wireless device 200a and the second wireless device 200b} may correspond to {the wireless device 100x and the BS 120} and/or {the wireless device 100x and the wireless device 100x} of FIG. 1.

The first wireless device 200a may include one or more processors 202a and one or more memories 204a and additionally further include one or more transceivers 206a and/or one or more antennas 208a. The processor(s) 202a may control the memory(s) 204a and/or the transceiver(s) 206a and may be configured to implement the descriptions, functions, procedures, proposals, methods, and/or operational flowcharts disclosed in this document. For example, the processor(s) 202a may process information within the memory(s) 204a to generate first information/signals and then transmit radio signals including the first information/signals through the transceiver(s) 206a. The processor(s) 202a may receive radio signals including second information/signals through the transceiver 206a and then store information obtained by processing the second information/signals in the memory(s) 204a. The memory(s) 204a may be connected to the processor(s) 202a and may store a variety of information related to operations of the processor(s) 202a. For example, the memory(s) 204a may store software code including commands for performing a part or the entirety of processes controlled by the processor(s) 202a or for performing the descriptions, functions, procedures, proposals, methods, and/or operational flowcharts disclosed in this document. Herein, the processor(s) 202a and the memory(s) 204a may be a part of a communication modem/circuit/chip designed to implement RAT (e.g., LTE or NR). The transceiver(s) 206a may be connected to the processor(s) 202a and transmit and/or receive radio signals through one or more antennas 208a. Each of the transceiver(s) 206a may include a transmitter and/or a receiver. The transceiver(s) 206a may be interchangeably used with Radio Frequency (RF) unit(s). In the present disclosure, the wireless device may represent a communication modem/circuit/chip.

The second wireless device 200b may include one or more processors 202b and one or more memories 204b and additionally further include one or more transceivers 206b and/or one or more antennas 208b. The processor(s) 202b may control the memory(s) 204b and/or the transceiver(s) 206b and may be configured to implement the descriptions, functions, procedures, proposals, methods, and/or operational flowcharts disclosed in this document. For example, the processor(s) 202b may process information within the memory(s) 204b to generate third information/signals and then transmit radio signals including the third information/signals through the transceiver(s) 206b. The processor(s) 202b may receive radio signals including fourth information/signals through the transceiver(s) 206b and then store information obtained by processing the fourth information/signals in the memory(s) 204b. The memory(s) 204b may be connected to the processor(s) 202b and may store a variety of information related to operations of the processor(s) 202b. For example, the memory(s) 204b may store software code including commands for performing a part or the entirety of processes controlled by the processor(s) 202b or for performing the descriptions, functions, procedures, proposals, methods, and/or operational flowcharts disclosed in this document. Herein, the processor(s) 202b and the memory(s) 204b may be a part of a communication modem/circuit/chip designed to implement RAT (e.g., LTE or NR). The transceiver(s) 206b may be connected to the processor(s) 202b and transmit and/or receive radio signals through one or more antennas 208b. Each of the transceiver(s) 206b may include a transmitter and/or a receiver. The transceiver(s) 206b may be interchangeably used with RF unit(s). In the present disclosure, the wireless device may represent a communication modem/circuit/chip.

Hereinafter, hardware elements of the wireless devices 200a and 200b will be described more specifically. One or more protocol layers may be implemented by, without being limited to, one or more processors 202a and 202b. For example, the one or more processors 202a and 202b may implement one or more layers (e.g., functional layers such as PHY, MAC, RLC, PDCP, RRC, and SDAP). The one or more processors 202a and 202b may generate one or more Protocol Data Units (PDUs) and/or one or more Service Data Unit (SDUs) according to the descriptions, functions, procedures, proposals, methods, and/or operational flowcharts disclosed in this document. The one or more processors 202a and 202b may generate messages, control information, data, or information according to the descriptions, functions, procedures, proposals, methods, and/or operational flowcharts disclosed in this document. The one or more processors 202a and 202b may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 206a and 206b. The one or more processors 202a and 202b may receive the signals (e.g., baseband signals) from the one or more transceivers 206a and 206b and acquire the PDUs, SDUs, messages, control information, data, or information according to the descriptions, functions, procedures, proposals, methods, and/or operational flowcharts disclosed in this document.

The one or more processors 202a and 202b may be referred to as controllers, microcontrollers, microprocessors, or microcomputers. The one or more processors 202a and 202b may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 202a and 202b. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 202a and 202b or stored in the one or more memories 204a and 204b so as to be driven by the one or more processors 202a and 202b. The descriptions, functions, procedures, proposals, methods, and/or operational flowcharts disclosed in this document may be implemented using firmware or software in the form of code, commands, and/or a set of commands.

The one or more memories 204a and 204b may be connected to the one or more processors 202a and 202b and store various types of data, signals, messages, information, programs, code, instructions, and/or commands. The one or more memories 204a and 204b may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 204a and 204b may be located at the interior and/or exterior of the one or more processors 202a and 202b. The one or more memories 204a and 204b may be connected to the one or more processors 202a and 202b through various technologies such as wired or wireless connection.

The one or more transceivers 206a and 206b may transmit user data, control information, and/or radio signals/channels, mentioned in the methods and/or operational flowcharts of this document, to one or more other devices. The one or more transceivers 206a and 206b may receive user data, control information, and/or radio signals/channels, mentioned in the descriptions, functions, procedures, proposals, methods, and/or operational flowcharts disclosed in this document, from one or more other devices. For example, the one or more transceivers 206a and 206b may be connected to the one or more processors 202a and 202b and transmit and receive radio signals. For example, the one or more processors 202a and 202b may perform control so that the one or more transceivers 206a and 206b may transmit user data, control information, or radio signals to one or more other devices. The one or more processors 202a and 202b may perform control so that the one or more transceivers 206a and 206b may receive user data, control information, or radio signals from one or more other devices. The one or more transceivers 206a and 206b may be connected to the one or more antennas 208a and 208b and the one or more transceivers 206a and 206b may be configured to transmit and receive user data, control information, and/or radio signals/channels, mentioned in the descriptions, functions, procedures, proposals, methods, and/or operational flowcharts disclosed in this document, through the one or more antennas 208a and 208b. In this document, the one or more antennas may be a plurality of physical antennas or a plurality of logical antennas (e.g., antenna ports). The one or more transceivers 206a and 206b may convert received radio signals/channels etc. from RF band signals into baseband signals in order to process received user data, control information, radio signals/channels, etc. using the one or more processors 202a and 202b. The one or more transceivers 206a and 206b may convert the user data, control information, radio signals/channels, etc. processed using the one or more processors 202a and 202b from the base band signals into the RF band signals. To this end, the one or more transceivers 206a and 206b may include (analog) oscillators and/or filters.

### Structure of Wireless Device Applicable to the Present Disclosure

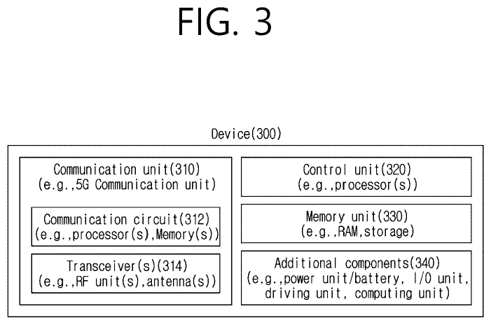

FIG. 3 is a view showing another example of a wireless device applicable to the present disclosure.

Referring to FIG. 3, a wireless device 300 may correspond to the wireless devices 200 a and 200 b of FIG. 2 and include various elements, components, units/portions and/or modules. For example, the wireless device 300 may include a communication unit 310, a control unit (controller) 320, a memory unit (memory) 330 and additional components 340. The communication unit may include a communication circuit 312 and a transceiver(s) 314. For example, the communication circuit 312 may include one or more processors 202 a and 202 b and/or one or more memories 204 a and 204 b of FIG. 2. For example, the transceiver(s) 314 may include one or more transceivers 206 a and 206 b and/or one or more antennas 208 a and 208 b of FIG. 2. The control unit 320 may be electrically connected with the communication unit 310, the memory unit 330 and the additional components 340 to control overall operation of the wireless device. For example, the control unit 320 may control electrical/mechanical operation of the wireless device based on a program/code/instruction/information stored in the memory unit 330. In addition, the control unit 320 may transmit the information stored in the memory unit 330 to the outside (e.g., another communication device) through the wireless/wired interface using the communication unit 310 over a wireless/wired interface or store information received from the outside (e.g., another communication device) through the wireless/wired interface using the communication unit 310 in the memory unit 330.

The additional components 340 may be variously configured according to the types of the wireless devices. For example, the additional components 340 may include at least one of a power unit/battery, an input/output unit, a driving unit or a computing unit. Without being limited thereto, the wireless device 300 may be implemented in the form of the robot (FIG. 1, 100 a), the vehicles (FIGS. 1, 100 b-1 and 100 b-2), the XR device (FIG. 1, 100 c), the hand-held device (FIG. 1, 100 d), the home appliance (FIG. 1, 100 e), the IoT device (FIG. 1, 100 f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 3, various elements, components, units/portions and/or modules in the wireless device 300 may be connected with each other through wired interfaces or at least some thereof may be wirelessly connected through the communication unit 310. For example, in the wireless device 300, the control unit 320 and the communication unit 310 may be connected by wire, and the control unit 320 and the first unit (e.g., 130 or 140) may be wirelessly connected through the communication unit 310. In addition, each element, component, unit/portion and/or module of the wireless device 300 may further include one or more elements. For example, the control unit 320 may be composed of a set of one or more processors. For example, the control unit 320 may be composed of a set of a communication control processor, an application processor, an electronic control unit (ECU), a graphic processing processor, a memory control processor, etc. In another example, the memory unit 330 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

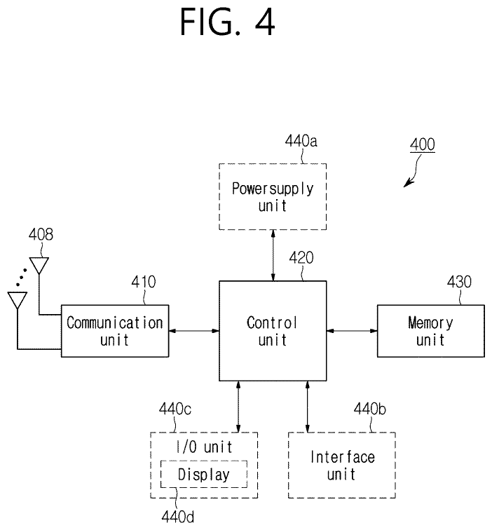

FIG. 4 is a view showing an example of a hand-held device applicable to the present disclosure.

FIG. 4 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 4, the hand-held device 400 may include an antenna unit (antenna) 408, a communication unit (transceiver) 410, a control unit (controller) 420, a memory unit (memory) 430, a power supply unit (power supply) 440 a, an interface unit (interface) 440 b, and an input/output unit 440 c. An antenna unit (antenna) 408 may be part of the communication unit 410. The blocks 410 to 430/440 a to 440 c may correspond to the blocks 310 to 330/340 of FIG. 3, respectively.

The communication unit 410 may transmit and receive signals (e.g., data, control signals, etc.) to and from other wireless devices or base stations. The control unit 420 may control the components of the hand-held device 400 to perform various operations. The control unit 420 may include an application processor (AP). The memory unit 430 may store data/parameters/program/code/instructions necessary to drive the hand-held device 400. In addition, the memory unit 430 may store input/output data/information, etc. The power supply unit 440 a may supply power to the hand-held device 400 and include a wired/wireless charging circuit, a battery, etc. The interface unit 440 b may support connection between the hand-held device 400 and another external device. The interface unit 440 b may include various ports (e.g., an audio input/output port and a video input/output port) for connection with the external device. The input/output unit 440 c may receive or output video information/signals, audio information/signals, data and/or user input information. The input/output unit 440 c may include a camera, a microphone, a user input unit, a display 440 d, a speaker and/or a haptic module.

For example, in case of data communication, the input/output unit 440 c may acquire user input information/signal (e.g., touch, text, voice, image or video) from the user and store the user input information/signal in the memory unit 430. The communication unit 410 may convert the information/signal stored in the memory into a radio signal and transmit the converted radio signal to another wireless device directly or transmit the converted radio signal to a base station. In addition, the communication unit 410 may receive a radio signal from another wireless device or the base station and then restore the received radio signal into original information/signal. The restored information/signal may be stored in the memory unit 430 and then output through the input/output unit 440 c in various forms (e.g., text, voice, image, video and haptic).

### Type of Wireless Device Applicable to the Present Disclosure

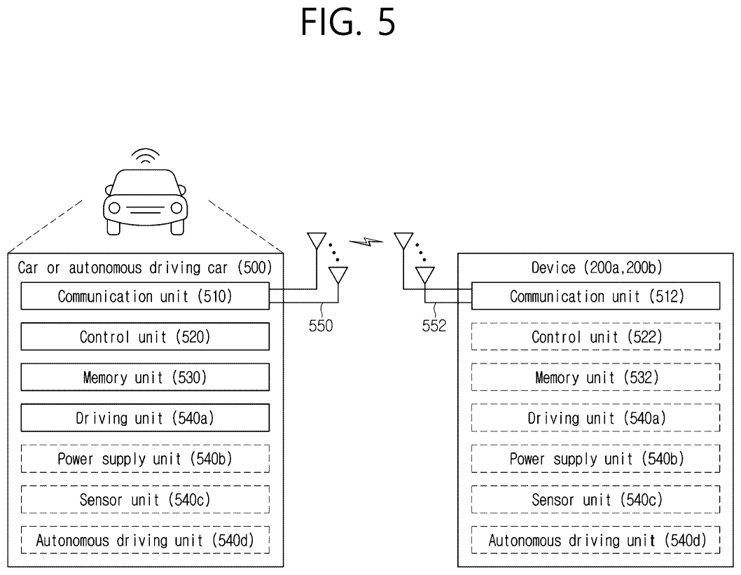

FIG. 5 is a view showing an example of a car or an autonomous driving car applicable to the present disclosure.

FIG. 5 shows a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited.

Referring to FIG. 5, the car or autonomous driving car 500 may include an antenna unit (antenna) 508, a communication unit (transceiver) 510, a control unit (controller) 520, a driving unit 540 a, a power supply unit (power supply) 540 b, a sensor unit 540 c, and an autonomous driving unit 540 d. The antenna unit 550 may be configured as part of the communication unit 510.

The blocks 510/530/540 a to 540 d correspond to the blocks 410/430/440 of FIG. 4.

The communication unit 510 may transmit and receive signals (e.g., data, control signals, etc.) to and from external devices such as another vehicle, a base station (e.g., a base station, a road side unit, etc.), and a server. The control unit 520 may control the elements of the car or autonomous driving car 500 to perform various operations. The control unit 520 may include an electronic control unit (ECU).

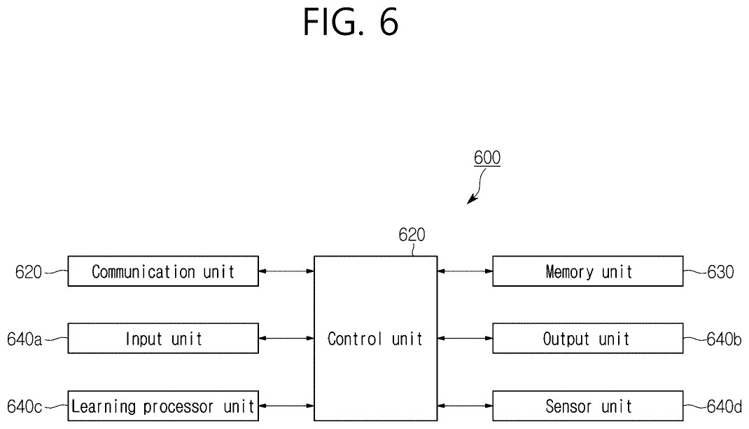

FIG. 6 is a view showing an example of artificial intelligence (AI) device applicable to the present disclosure. For example, the AI device may be implemented as fixed or movable devices such as a TV, a projector, a smartphone, a PC, a laptop, a digital broadcast terminal, a tablet PC, a wearable device, a set-top box (STB), a radio, a washing machine, a refrigerator, a digital signage, a robot, a vehicle, or the like.

Referring to FIG. 6, the AI device 600 may include a communication unit (transceiver) 610, a control unit (controller) 620, a memory unit (memory) 630, an input/output unit 640 a/640 b, a leaning processor unit (learning processor) 640 c and a sensor unit 640 d. The blocks 610 to 630/640 a to 640 d may correspond to the blocks 310 to 330/340 of FIG. 3, respectively.

The communication unit 610 may transmit and receive wired/wireless signals (e.g., sensor information, user input, learning models, control signals, etc.) to and from external devices such as another AI device (e.g., FIG. 1, 100 x, 120 or 140) or the AI server (FIG. 1, 140) using wired/wireless communication technology. To this end, the communication unit 610 may transmit information in the memory unit 630 to an external device or transfer a signal received from the external device to the memory unit 630.

The control unit 620 may determine at least one executable operation of the AI device 600 based on information determined or generated using a data analysis algorithm or a machine learning algorithm. In addition, the control unit 620 may control the components of the AI device 600 to perform the determined operation. For example, the control unit 620 may request, search for, receive or utilize the data of the learning processor unit 640 c or the memory unit 630, and control the components of the AI device 600 to perform predicted operation or operation, which is determined to be desirable, of at least one executable operation. In addition, the control unit 620 may collect history information including operation of the AI device 600 or user's feedback on the operation and store the history information in the memory unit 630 or the learning processor unit 640 c or transmit the history information to the AI server (FIG. 1, 140). The collected history information may be used to update a learning model.

The memory unit 630 may store data supporting various functions of the AI device 600. For example, the memory unit 630 may store data obtained from the input unit 640 a, data obtained from the communication unit 610, output data of the learning processor unit 640 c, and data obtained from the sensing unit 640. In addition, the memory unit 630 may store control information and/or software code necessary to operate/execute the control unit 620.

The input unit 640 a may acquire various types of data from the outside of the AI device 600. For example, the input unit 640 a may acquire learning data for model learning, input data, to which the learning model will be applied, etc. The input unit 640 a may include a camera, a microphone and/or a user input unit. The output unit 640 b may generate video, audio or tactile output. The output unit 640 b may include a display, a speaker and/or a haptic module. The sensing unit 640 may obtain at least one of internal information of the AI device 600, the surrounding environment information of the AI device 600 and user information using various sensors. The sensing unit 640 may include a proximity sensor, an illumination sensor, an acceleration sensor, a magnetic sensor, a gyro sensor, an inertia sensor, a red green blue (RGB) sensor, an infrared (IR) sensor, a finger scan sensor, an ultrasonic sensor, an optical sensor, a microphone and/or a radar.

The learning processor unit 640 c may train a model composed of an artificial neural network using training data. The learning processor unit 640 c may perform AI processing along with the learning processor unit of the AI server (FIG. 1, 140). The learning processor unit 640 c may process information received from an external device through the communication unit 610 and/or information stored in the memory unit 630. In addition, the output value of the learning processor unit 640 c may be transmitted to the external device through the communication unit 610 and/or stored in the memory unit 630.

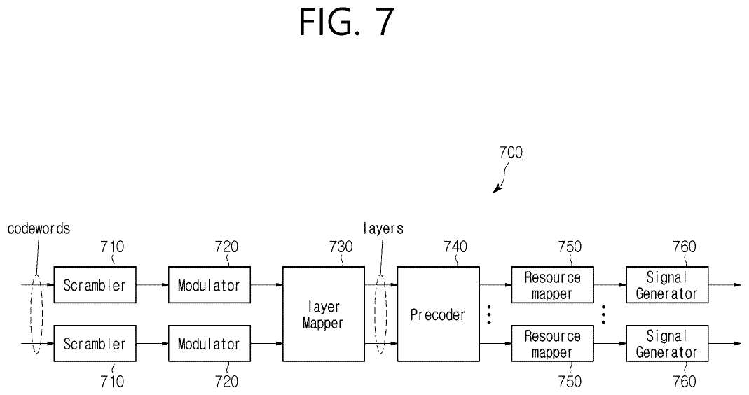

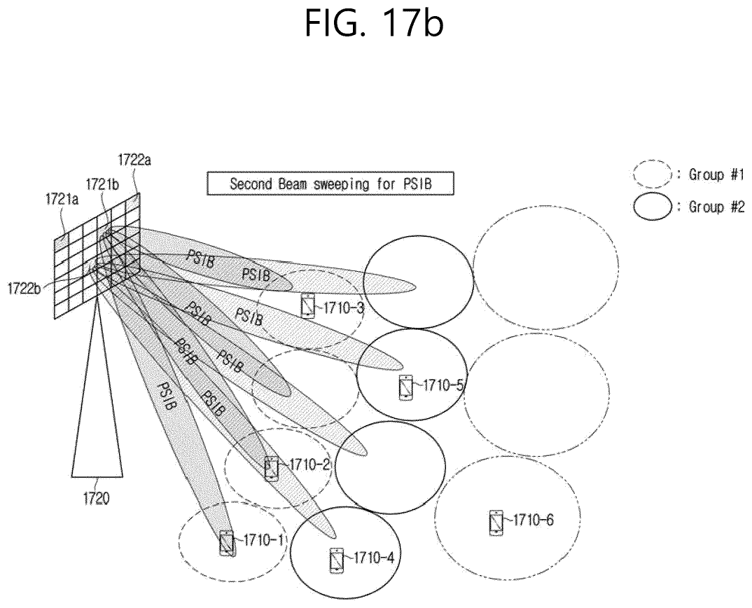

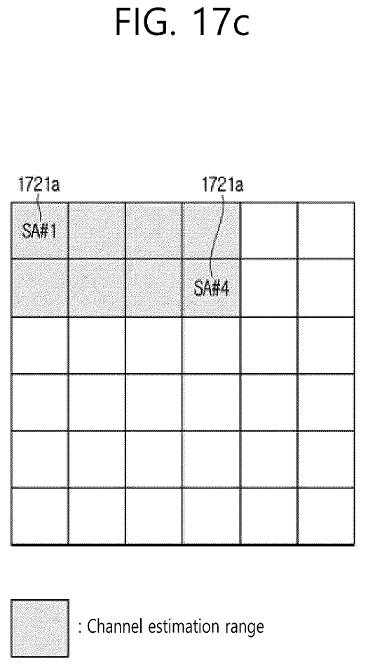

FIG. 7 shows a signal process circuit for a transmission signal, based on an embodiment of the present disclosure. For example, a signal processing circuit 700 may include scramblers 710, modulators 720, a layer mapper 730, a precoder 740, resource mappers 750, and signal generators 760. Here, for example, an operation/function of FIG. 2 may be performed, in the processors 202a and 202b and/or the transceivers 206a and 206b of FIG. 17. Hardware elements of FIG. 7 may be implemented by the processors 202a and 202b and/or the transceivers 206a and 206b of FIG. 17. For example, blocks 710 to 760 may be implemented by the processors 202a and 202b of FIG. 17. Alternatively, the blocks 710 to 750 may be implemented by the processors 202a and 202b of FIG. 17 and the block 760 may be implemented by the transceivers 206a and 206b of FIG. 17, and not limited to the above embodiment.

Codewords may be converted into radio signals via the signal processing circuit 700 of FIG. 7. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH). Specifically, the codewords may be converted into scrambled bit sequences by the scramblers 710. Scramble sequences used for scrambling may be generated based on an initialization value, and the initialization value may include ID information of a wireless device. The scrambled bit sequences may be modulated to modulation symbol sequences by the modulators 720. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 730. Modulation symbols of each transport layer may be mapped (precoded) to corresponding antenna port(s) by the precoder 740. Outputs z of the precoder 740 may be obtained by multiplying outputs y of the layer mapper 730 by an N*M precoding matrix W. Herein, N is the number of antenna ports and M is the number of transport layers. The precoder 740 may perform precoding after performing transform precoding (e.g., DFT) for complex modulation symbols. Alternatively, the precoder 740 may perform precoding without performing transform precoding.

The resource mappers 750 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 760 may generate radio signals from the mapped modulation symbols and the generated radio signals may be transmitted to other devices through each antenna. For this purpose, the signal generators 760 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 710 to 760 of FIG. 7. For example, the wireless devices (e.g., 200a and 200b of FIG. 17) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

### 6G Communication System

The 6G (wireless communication) system aims at (i) very high data rates per device, (ii) a very large number of connected devices, (iii) global connectivity, (iv) very low latency, (v) lower energy consumption of battery-free IoT devices, (vi) ultra-reliable connectivity, and (vii) connected intelligence with machine learning capabilities. The vision of the 6G system can be divided into four aspects: “intelligent connectivity”, “deep connectivity”, “holographic connectivity”, and “ubiquitous connectivity”, and the 6G system can satisfy the requirements as shown in Table 1 below. That is, Table 1 is a table showing the requirements of the 6G system.

TABLE 1

| | |
|---|---|
| Per device peak data | 1 Tbps |
| rate | |
| E2E latency | 1 ms |
| Maximum spectral | 100 |
| efficiency | bps/Hz |
| Mobility support | up to |
| | 1000 km/hr |
| Satellite integration | Fully |
| AI | Fully |
| Autonomous vehicle | Fully |
| XR | Fully |
| Haptic Communication | Fully |

At this time, 6G systems may have key factors such as enhanced mobile broadband (eMBB), ultra-reliable low latency communications (URLLC), massive machine type communications (mMTC), AI integrated communication, tactile internet, high throughput, high network capacity, high energy efficiency, low backhaul and access network congestion, and enhanced data security.

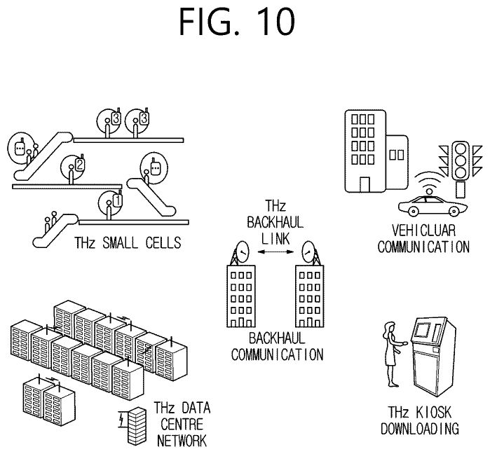

FIG. 10 is a diagram illustrating an example of a communication structure that can be provided in a 6G system applicable to the present disclosure.

Referring to FIG. 10, the 6G system is expected to have 50 times higher simultaneous wireless communication connectivity than the 5G wireless communication system. URLLC, a key feature of 5G, is expected to become a more important technology in 6G communication by providing end-to-end delay of less than 1 ms. At this time, the 6G system will have much better volumetric spectral efficiency than the frequently used area spectral efficiency. The 6G system can provide very long battery life and advanced battery technology for energy harvesting, so that mobile devices in the 6G system may not need to be charged separately. In addition, new network characteristics in 6G may be as follows.

### Core Enabling Technology for 6G Systems-THz (Terahertz) Communication

THz communication can be applied in 6G systems. For example, the data transmission rate can be increased by increasing the bandwidth. This can be done by using sub-THz communication with a wide bandwidth and applying advanced massive MIMO technology.

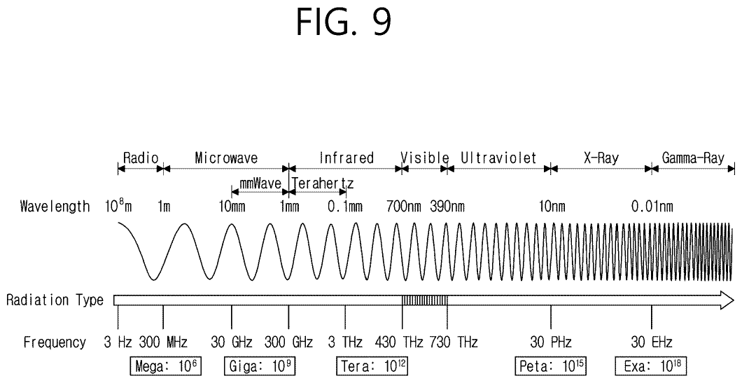

FIG. 9 is a diagram illustrating an electromagnetic spectrum applicable to the present disclosure. As an example, referring to FIG. 9, THz waves, also known as sub-millimeter radiation, typically exhibit a frequency band between 0.1 THz and 10 THz with a corresponding wavelength ranging from 0.03 mm to 3 mm. The 100 GHz to 300 GHz band range (Sub THz band) is considered to be a major part of the THz band for cellular communications. Adding the Sub-THz band to the mm Wave band will increase the capacity of 6G cellular communications. Among the defined THz bands, 300 GHz to 3 THz is in the far infrared (IR) frequency band. The 300 GHz to 3 THz band is a part of the optical band, but is at the boundary of the optical band, just behind the RF band. Therefore, this 300 GHz to 3 THz band exhibits similarities with RF.

Key characteristics of THz communications include (i) widely available bandwidth to support very high data rates, and (ii) high path loss at high frequencies (highly directional antennas are essential). The narrow beam widths generated by highly directional antennas reduce interference. The small wavelength of THz signals allows a much larger number of antenna elements to be integrated into devices and BSs operating in this band. This allows the use of advanced adaptive array techniques to overcome range limitations.

### Terahertz (THz) Wireless Communications

FIG. 10 is a diagram illustrating a THz communication method applicable to the present disclosure.

Referring to FIG. 10, THz wireless communication is a wireless communication using THz waves having a frequency of approximately 0.1 to 10 THz (1 THz=1012 Hz), and may refer to terahertz (THz) band wireless communication using a very high carrier frequency of 100 GHz or higher. THz waves are located between the RF (Radio Frequency)/millimeter (mm) and infrared bands, and (i) compared to visible light/infrared rays, they penetrate non-metallic/non-polarizable materials well, and compared to RF/millimeter waves, they have a shorter wavelength, so they have high straightness and can enable beam focusing.

### Reflecting Intelligent Surface (RIS)

RIS is one of the leading candidate technologies for future wireless communication. It is a surface with a plurality of component elements that reflect signals. Each component element can independently change the phase of the colliding electromagnetic waves. One of the main features of RIS is that it is controllable, meaning that the phase change rate of each element can be adjusted in real time. Based on the adjustment of the phase change rate, the wireless communication channel may be modified in real time, such as to increase the information delivery rate or to assist devices that cannot receive a signal. In addition, since RIS is using passive elements that only reflect signals, it can be implemented at a low cost and with low power consumption.

A metamaterial, an element that causes the reflection of a signal, may be implemented in a variety of ways. For example, metamaterials may be implemented based on a diode scheme using a metallic material, a scheme using a liquid crystal, or a scheme using graphene (e.g., a scheme combining graphene and metal using surface plasmon polariton (SPP)). Metamaterials may be implemented in a variety of other ways. The elements comprising the metamaterial may be controlled by a controller. By controlling each of the elements, the controller may adjust the rate of phase change applied when a signal is reflected from each of the elements. For example, a base station or a separate device may function as the controller.

In some cases, an RIS may further include active elements in addition to passive elements. An active element is an element that has the ability to process the incoming signal, rather than simply reflecting it. An active element may be implemented by connecting a receiving RF chain to a passive element. While active elements may compromise the low cost and low complexity features of RIS, they can allow for more versatile and flexible system operation. Active elements are sometimes referred to as active sensors.

### Specific Embodiments of the Disclosure

The present disclosure is related to an initial access procedure in a wireless communication system. In specific, the present disclosure describes techniques for performing a sub-array based initial access procedure that considers a Fresnel zone.

To overcome the path loss of signals in the 6G channel environment in the THz band, it is considered to use narrow beams with a narrow beamwidth with high beam gain. If communication is performed based on a narrow beam, the number of narrow beams generated by a base station will be very large, and accordingly, the area covered by each narrow beam will be very narrow. As a result, beam misalignment due to errors in UE movement, channel estimation, etc. may occur frequently. In addition, the increase in the number of narrow beams that the base station must cover may significantly increase the beam sweeping time required for initial connection. Furthermore, due to the narrow beams, there may be cases where there are no communicating UEs in the vicinity, making it difficult to receive the physical data shared channel (PDSCH), which includes the system information block (SIB) information required for the initial connection. Therefore, this disclosure proposes a new type of early access technology that considers the channel variation features of Fresnel zone channels, which are different from the far-field channel features of 5G.

In the present disclosure, a beam refers to a signal formed to be directional using a plurality of antenna elements, or a weighting or filter for forming a signal. In the present disclosure, a beam may be referred to as a spatial domain filter or any other term having an equivalent technical meaning.

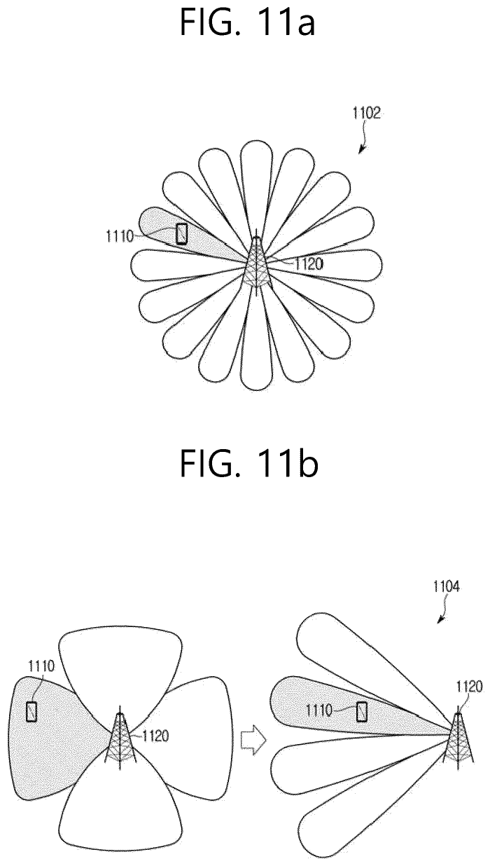

FIGS. 11A and 11B show examples of beam sweeping to explore a narrow beam covering a UE. FIG. 11a shows an exhaustive search scheme 1102 and FIG. 11b shows an iterative search scheme 1104. As shown in FIGS. 11A and 11B, for a UE 1110 that is seeking to perform an initial access, a base station 1120 may transmit beams via beam sweeping sequentially within its coverage area. Referring to FIG. 11A, the base station 1120 may identify a narrow beam that covers the UE 1110 by sequentially using narrow beams in all directions according to the exhaustive search scheme 1102. Referring to FIG. 11B, the base station 1120 may identify a narrow beam covering the UE 1110 by using the wide beams and the narrow beams in a stepwise manner according to the iterative search scheme 1104. The exhaustive search scheme 1102 is appropriate for users located near an edge, but may result in high discovery delays. The iterative search scheme 1104 has a relatively small searching delay, but may be disadvantageous for users located near the edge.

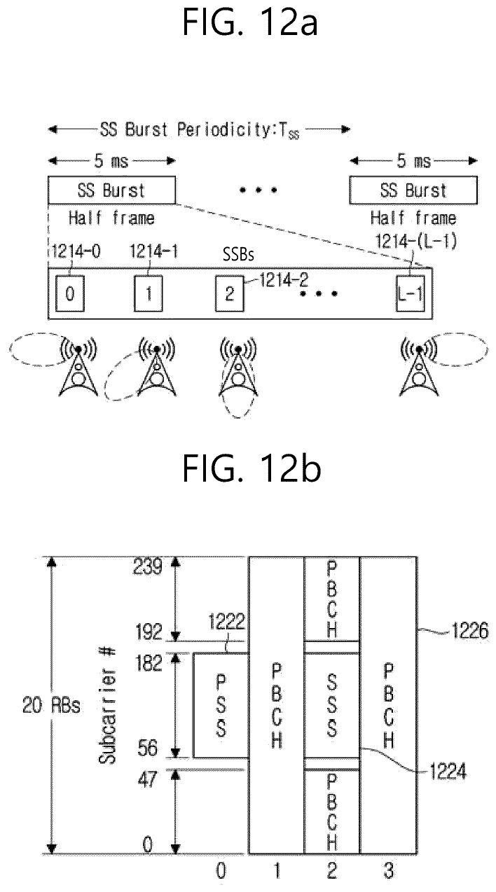

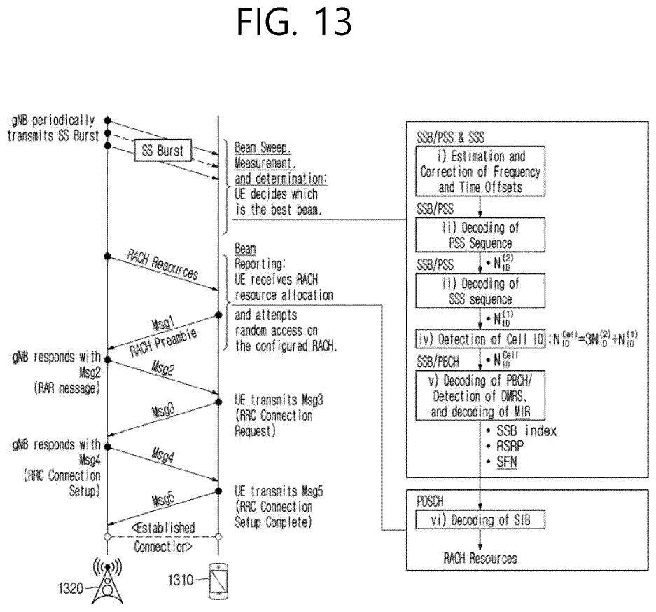

FIG. 12a shows an example of synchronization signal block (SSB) transmission with beam sweeping. FIG. 12a shows beam sweeping for SSB and FIG. 12b shows the structure of the SSB. Referring to FIG. 12a, each beam delivers the SSB at an independent time. Specifically, a plurality of synchronization signal (SS) bursts are transmitted according to a period TSS, wherein one SS burst includes a plurality of SSBs 1214-0 to 1214-(L-1). In this case, the plurality of SSBs 1214-0 to 12104-(L-1) are transmitted via L beams in different directions. The structure of each of the SSBs 1204-0 to 1204-(L-1) is shown in FIG. 12b. FIG. 12b shows an example structure of an SSB. Referring to FIG. 12b, the SSB includes a primary synchronization signal (PSS) 1222, a secondary synchronization signal (SSS) 1224, and a physical broadcast channel (PBCH) 1226. As the number of beams increases, the number of symbols allocated to transmit the SSBs increases, and the time required may also increase.

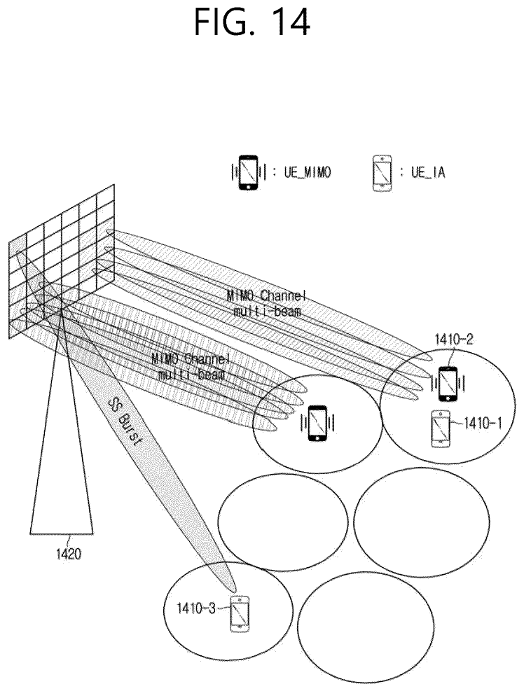

FIG. 13 shows an example of an initial access procedure based on an SS burst. Referring to FIG. 13, an SS burst transmission using beam sweeping between the UE 1310 and the gNB 1320, a random access channel (RACH) resource information transmission, a message 1 (MSG1) transmission including a RACH preamble, a message 2 (MSG2) transmission including a random access response (RAR) message, and a message 3 (MSG3) transmission including a RRC connection request message, a message 4 (MSG4) transmission including an RRC connection setup message, and a message 5 (MSG5) transmission including an RRC connection setup complete message, whereby the UE 1310 and the gNB 1320 may obtain an established connection. Here, during the SS burst transmission, the UE 1310 may perform measurements and select the best beam based on the measurements. More specifically, the UE 1310 may estimate and correct the frequency and time offset using the PSS and SSS, decode the PSS and SSS to determine the PSS sequence and the SSS sequence, detect the cell identifier (cell ID), detect the demodulation reference signal (DMRS), and decode the master information block (MIB). This allows the UE 1310 to obtain the SSB index, reference signal received power (RSRP), and system frame number (SFN), i.e., the UE 1310 estimates the basic time and frequency offset from the SS burst, estimates the cell ID, beam index information, and decodes the SIB transmitted via PDSCH to obtain information for the RACH resource, and performs initial access via RACH preamble feedback.

As communication systems evolve from 5G to 6G, beamforming changes from 2D to 3D. To achieve high beam gains, 3D beamforming is more effective because it concentrates signal gain in both horizontal and vertical directions. In this case, the number of beams may be significantly increased, as shown in Table 2 below. [Table 2] shows an example of the number of beams that would be demanded within a 120° sector.

TABLE 2

| | | Antenna | The number of |
|---|---|---|---|
| Diameter | Beamforming | Array | beams |
| 100 m | 2D | 10 × 4 | 32 |
| | 3D | 28 × 28 | 626 |
| 300 m | 2D | 16 × 8 | 117 |
| | 3D | 50 × 50 | 2203 |

In [Table 2], the antenna array size is determined by considering the path loss in the 5G 28 GHz and 6G 140 GHz bands. As mentioned above, as the number of beams increases, the number of SSB transmissions increases, and accordingly, the number of pilots for beam sweeping may increase and the period may become longer.

In the initial access procedure previously described with reference to FIG. 13, the UE 1310 receives the PDSCH transmitted after beam sweeping for the SS burst. This is based on assumption that the UE 1310 can receive communication signals to neighboring UEs. However, this assumption may not hold in environments where narrow beams are used.

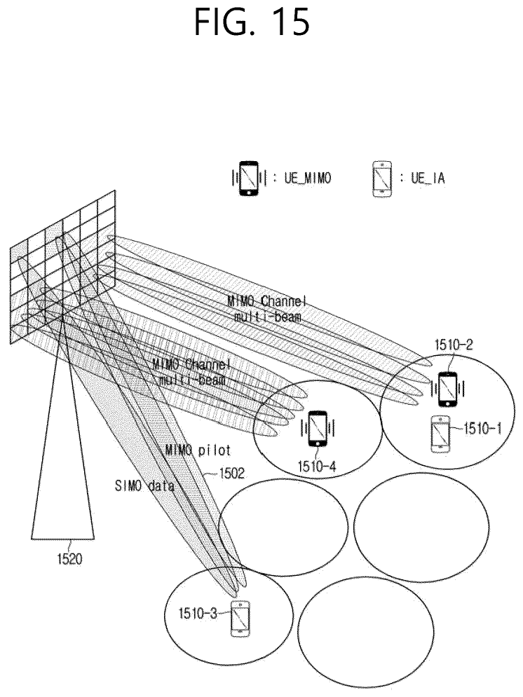

FIG. 14 shows an example of a situation where narrow beams are used. Referring to FIG. 14, in a narrow beam environment, each beam has a corresponding beam coverage. The beam coverage may be referred to as a beam zone, beam sector, beam region, or the like. If the first UE 1410-1 performing the initial access and the second UE 1410-2 already connected to the network and in MIMO communication are sharing the same beam, the first UE 1410-1 may receive the SIB that includes the RACH resource information via PDSCH because it is located within the coverage of the beam for data communication. However, since there are no UEs communicating in MIMO in the vicinity of the third UE 1410-3 performing another initial access, the third UE 1410-3 may have difficulty receiving a PDSCH.

Previously, the problem of time delay due to the increase in the number of beams for beam sweeping due to the use of narrow beams and the difficulty of receiving SIBs that includes RACH resource information were described. Next, the complexity of MIMO allocation is described.

The far-field region of 5G has a rank of 1 in a line of sight (LoS) environment, whereas the THz band can provide high rank in a LOS environment due to its Fresnel zone channel characteristics. Due to these characteristics, in 5G systems, UEs typically use four to eight RF chains in a single beam area, and the RF chains do not change significantly from beam to beam. However, for 6G Fresnel zone channels, the allocation of dozens of RF-chains is possible, which makes MIMO allocation (e.g., RF-channel allocation, MIMO precoding) very complex.

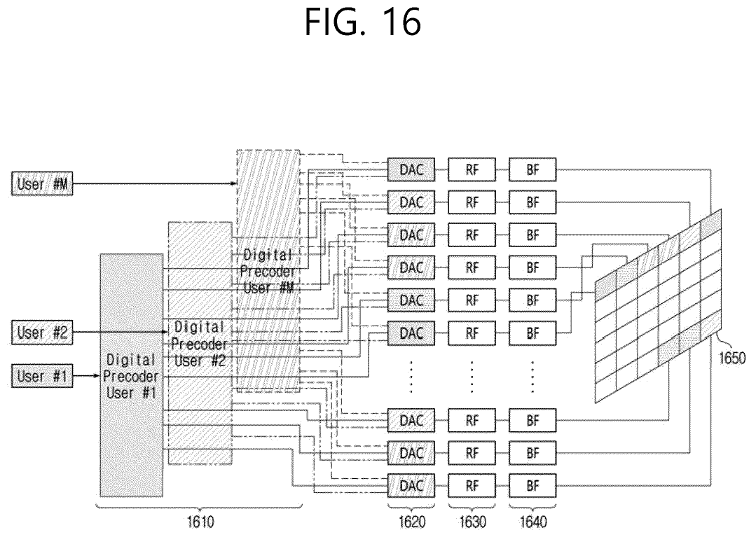

FIG. 15 shows an example transmission of MIMO data and MIMO pilot in a narrow beam environment. Referring to FIG. 15, the first UE 1510-1 and the third UE 1510-3 are performing initial access, and the second UE 1510-2 and the fourth UE 1510-4 are performing MIMO communication. The second UE (1510-2) is receiving MIMO data and MIMO pilot simultaneously. Since the first UE 1510-1 and the second UE 1510-2 are located within the coverage of the same narrow beam set, the first UE 1510-1 may perform channel estimation via the MIMO pilot, and the base station 1520 may perform beam refinement and MIMO allocation based on the results of the channel estimation. However, since there are no other UEs in MIMO communication within the coverage area where the third UE 1510-3 is located, additional RF-chain allocation is required to form beams 1502 delivering MIMO pilots for the third UE 1510-3, as shown in FIG. 15. In this case, it becomes difficult to transmit data other than the pilot on the additional allocated beams. As a result, throughput may be reduced due to the inability to transmit data, and beam allocation, MIMO allocation via channel feedback, may take a long time.

Accordingly, the present disclosure describes various embodiments of novel initial access techniques to address the complexity of the initial access procedure due to narrow beams, SIB reception issues, complexity of MIMO allocation, and the like. In the present disclosure, a pilot is a signal that has a pre-promised value and is used for channel estimation, and may be referred to as a “reference signal.

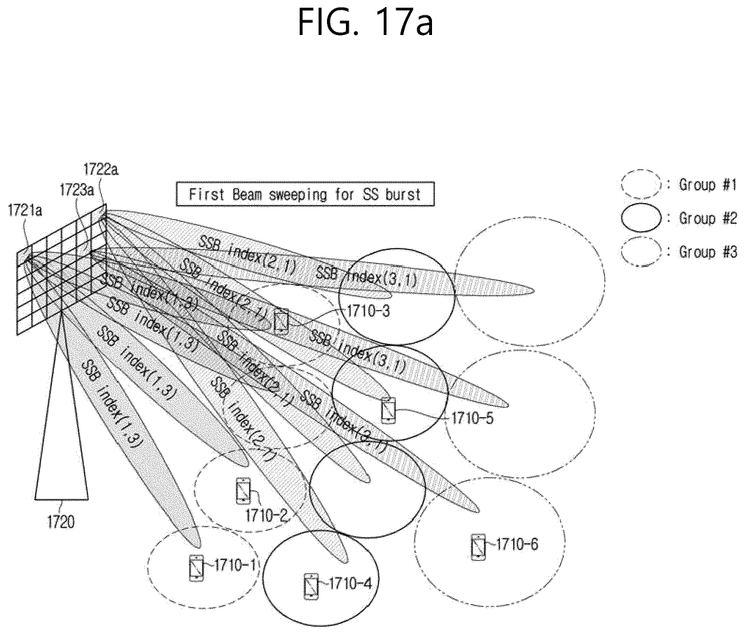

FIG. 16 shows an example of an RF system according to one embodiment of the present disclosure. FIG. 6 shows an example of a subarray-based system. Referring to FIG. 16, the RF system includes a digital precoder 1610, DACs 1620, RF chains 1630, beamformers (BFs) 1640, and an antenna array 1650.

The data to the plurality of users is precoded by the digital precoder 1610. Here, the digital precoder 1610 may be described as functionally including a plurality of precoders. The DACs 1620 are distributed to the users, and the set of DACs allocated for each user converts the data to an analog signal. The outputs of the DACs 1620 are processed (e.g., frequency upconverted, etc.) by the RF chains 1630. The antenna array 1650 includes a plurality of subarrays, each of which is used to transmit a beam formed by a corresponding beamformer among the beamformers 1640.

The beamformer and subarrays corresponding to each subarray refer to an antenna system capable of beam control, and may be replaced by beamforming means based on one of a beam control system using a meta surface, a rotman lens, or a butler matrix. Each DAC may also have full-digital form, with connections from one subarray to all subarrays. In the case of full-digital, the subarray may be a single antenna.

To address the aforementioned SIB reception issues, system according to various embodiments of the disclosure supports beam sweeping operation for SIB. Beam sweeping for SS bursts and SIBs according to various embodiments of the present disclosure is shown in FIGS. 17a and 17b below. FIGS. 17a and 17b show examples of beam sweeping for SS bursts and beam sweeping for system information, according to one embodiment of the present disclosure.

FIG. 17a shows an example of beam sweeping for an SS burst. Referring to FIG. 17a, a plurality of UEs 1710-1 to 1710-6 are distributed within the coverages of the base station 1720. For synchronized obtaining and measurement of the plurality of UEs 1710-1 to 1710-6, the base station 1720 may repeatedly transmit an SSB included in an SS burst using a plurality of beams. In this case, one coverage may be provided by one beam, and the plurality of coverages may be categorized into at least one coverage group according to predefined criteria (e.g., distance, Fresnel zone channel characteristics). In the case of FIG. 17, the coverages are categorized into three coverage groups. For one coverage, one subarray is allocated. Accordingly, beam sweeping toward the first coverage group is performed using subarray #1 (1721a), beam sweeping toward the second coverage group is performed using subarray #2 (1722a), and beam sweeping toward the third coverage group is performed using subarray #3 (1723a).

FIG. 17b shows an example of beam sweeping for system information. Referring to FIG. 17b, a plurality of UEs 1710-1 to 1710-6 are distributed within the coverages of the base station 1720. To transmit system information (e.g., SIB), including RACH resource information, to the plurality of UEs 1710-1 to 1710-6, the base station 1720 may transmit the system information repeatedly using a plurality of beams. In addition, for estimating the MIMO channel of the plurality of UEs 1710-1 to 1710-6, the base station 1720 may transmit pilots along with the system information. That is, according to one embodiment, the base station 1720 may transmit a signal that includes the system information and the pilots via beam sweeping.

In the present disclosure, a signal including system information and pilot may be referred to as PSIB (pilot and SIB). In the case of FIG. 17b, a PSIB is transmitted via beam sweeping toward coverage group #1 and coverage group #2. Although not shown in FIG. 17b, PSIBs may further be transmitted via beam sweeping toward coverage group #3. subarray #4 (1721b) is used for beam sweeping toward coverage group #1, and subarray #5 (1722b) is used for beam sweeping toward coverage group #2. Then, since subarray #1 (1721a) and subarray #4 (1721b) are used for beam sweeping toward coverage group #1, subarray #1 (1721a) and subarray #4 (1721b) form one subarray group. Similarly, since subarray #2 (1722a) and subarray #5 (1722b) are used for beam sweeping toward coverage group #1, subarray #2 (1722a) and subarray #5 (1722b) form the other subarray group. The two subarrays in each subarray group form an antenna aperture for that corresponding coverage group. For example, the aperture formed by subarray #1 (1721a) and subarray #4 (1721b) is shown in FIG. 17c. FIG. 17c shows an example of a range of MIMO channel estimates according to subarray allocation according to one embodiment of the present disclosure. FIG. 17c shows an example of the range of MIMO channel estimation related to subarray #1 (1721a) and subarray #4 (1721b) used for beam sweeping toward the first coverage group. Since SSB is transmitted through subarray #1 (1721a) and PSIB is transmitted through subarray #4 (1721b), the UE (e.g: UE 1710-1 or UE 1710-3) may estimate the channel between subarray #1 1721a and the UE's receiving antenna (hereinafter referred to as “channel value for subarray #1 1721a”) and the channel between subarray #4 1721b and the UE's receiving antenna (hereinafter referred to as “channel value for subarray #4 1721b”). Then, based on the channel value for subarray #1 1721a and the channel value for subarray #4 1721b, the UE may obtain channel values for other subarrays within the channel estimation region. For example, the UE may obtain channel values for the other subarrays based on at least one of an antenna structure of the base station 1720, a transmission/reception distance, and a signal incidence angle. In one embodiment, the UE may obtain channel values for different subarrays within the channel estimation region based on an interpolation calculation for the channel value for subarray #1 1721a and the channel value for subarray #4 1721b. Further, based on an extrapolation calculation for at least one channel value among the subarrays within the channel estimation region, channel values for other subarrays within the channel estimation region may be obtained. That is, using the channel values for the at least one subarray used to transmit SSB (e.g., subarray #1 (1721a)) and the channel values for the at least one subarray used to transmit PSIB (e.g., subarray #4 (1721b)), the UE may determine the channel values for all or some of the subarrays included in the antenna of the base station 1720.

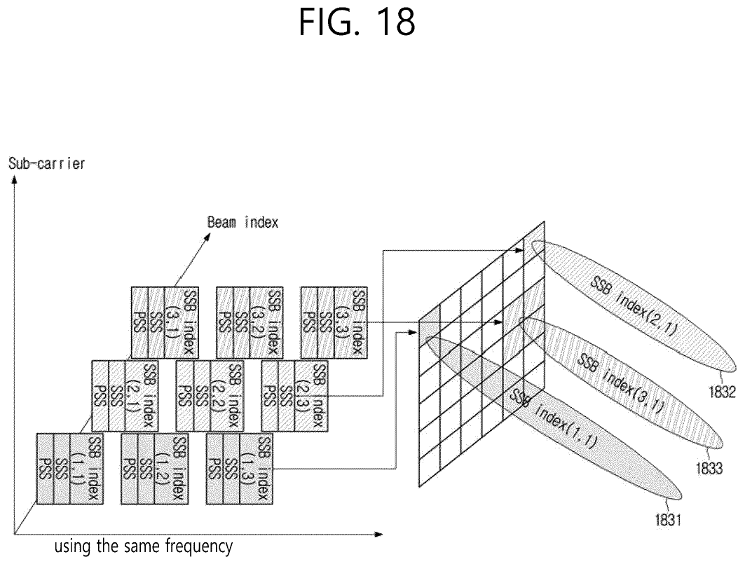

As shown in FIGS. 17a and 17b, two kinds of beam sweeping such as first beam sweeping for SS burst transmission and second beam sweeping for system information (e.g., SIB) and pilot transmission may be performed. In FIG. 18, the PSIB is a signal that includes SIB information and a pilot used for channel estimation for MIMO allocation. The subarrays that perform sweeping for SS burst transmissions and the subarrays that perform beam sweeping for PSIB transmissions may be independent of each other. Accordingly, the subarrays may be used for MIMO allocation.

In the embodiments described with reference to FIGS. 17A and 17B, a single subarray is used to form a single beam. However, according to other embodiments, a single beam may be formed using a plurality of subarrays, i.e., a subarray set. Specifically, in FIG. 17a, subarray #1 1721a may be replaced with a subarray set that includes N×M subarrays that are adjacent to each other. Similarly, in FIG. 17b, subarray #4 1721b may be replaced with a subarray set that includes N×M subarrays that are adjacent to each other. In the following description, a subarray set may be understood to include one or more subarrays.

As described above, two or more subarrays are allocated to one coverage group to transmit SS bursts and system information. The subarrays may be allocated as follows For initial access, beam regions with similar Fresnel zone channel characteristics, i.e., coverages, are grouped, and subarrays for transmitting SS bursts and PSIBs are allocated to each group. Here, to maximize the gain of the Fresnel zone channel, the subarrays may be allocated such that the size of the antenna aperture varies with distance. For a UE at a close distance, the characteristics of the Fresnel zone channel are maintained even if the antenna aperture is small. Therefore, the coverage is categorized into a plurality of groups such that each group has the same Fresnel zone channel characteristics. Then, the base station determines the antenna aperture size by allocating a subarray group or set for one group, and performs beam sweeping for each group. For example, in FIG. 17B, beam sweeping is performed using an independent subarray group or set for a group that includes coverages with the same characteristics, such as coverage group #1 or coverage group #2. Further, the subarrays for the group may be allocated to provide antenna aperture sizes sufficient to enable MIMO channel estimation.

Beam sweeping for SSB transmission may be performed for each coverage group, as shown in FIG. 17a. In this case, since the beams are separated per group, it is possible to transmit SS bursts toward a plurality of coverage groups simultaneously. Thus, instead of transmitting only one SSB during one transmission occasion, as many SSBs as there are coverage groups may be transmitted during one transmission occasion. FIG. 18 shows an example of multi-beam SSB transmission according to one embodiment of the present disclosure. FIG. 18 shows a situation where SSBs are transmitted towards three coverage groups. The SSB index is defined as (group index, beam index), and three SSBs may be transmitted during one transmit occasion, i.e., SSB 1831 with index 1,1, SSB 1832 with index 2,1, and SSB 1833 with index 3,1. In this way, the beam sweeping time may be significantly reduced.

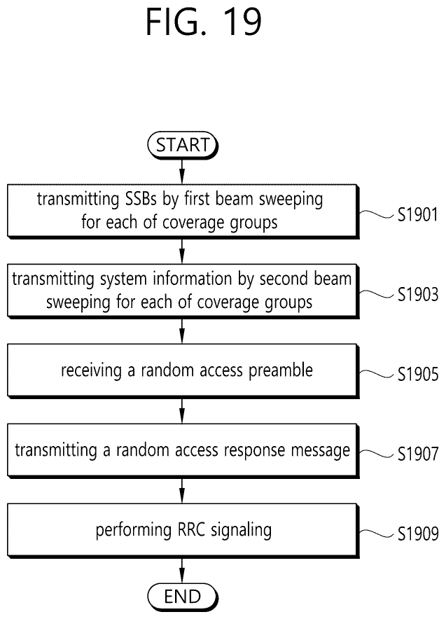

FIG. 19 shows an example of a procedure to support initial access according to one embodiment of the present disclosure. FIG. 19 exemplifies an operation method of a base station. Referring to FIG. 19, in step S1901, a base station transmits SSBs by first beam sweeping for each of the coverage groups. The coverage groups are determined by categorizing the plurality of beam coverages by distance, and the first beam sweeping causes beams to be formed sequentially toward the beam coverages included in each coverage group. By forming a plurality of beams for the plurality of coverage groups, the base station may transmit SSBs to the plurality of coverage groups during a single transmission occasion.

In step S1903, the base station transmits system information by second beam sweeping for each of the coverage groups. The system information may include a SIB, and the SIB may include information related to the RACH resources. For one coverage group, the base station may sequentially form beams toward the coverages belonging to the corresponding coverage group and transmit the system information via the formed beams. In this case, the base station may transmit SSBs to a plurality of coverage groups during a single transmission occasion by forming a plurality of beams for a plurality of coverage groups. Here, according to an embodiment, along with the system information, reference signals for channel estimation may be transmitted.

In step S1905, the base station receives the random access preamble. The base station may receive the random access preamble transmitted from one of the RACH occasions included in the RACH resource indicated by the system information. The random access preamble includes one of a predefined sequences. Based on the time-frequency location of the RACH occasion in which the random access preamble is detected, the base station may identify the SSB transmitted via the UE's preferred transmission beam. According to one embodiment, the random access preamble may include MIMO channel information estimated by the UE.

In step S1907, the base station transmits a RAR message. The base station may transmit the RAR message based on information related to the detected RACH preamble. Specifically, the base station may generate and transmit downlink control information (DCI) using a radio network temporary identifier (RNTI) determined based on at least one of a symbol index, a slot index, and a frequency axis index to which the RACH preamble is mapped, and then transmit the RAR message through a resource indicated by the DCI. The RAR message may include at least one of information related to the transmission timing of the UE, information related to the resource allocated for transmitting the MSG3, and identification information allocated to the UE.

In step S1909, the base station performs RRC signaling. The base station may perform signaling to establish a connection with the UE. Specifically, the base station may transmit a message for contention resolution and receive a message requesting to establish a connection. Accordingly, the base station and the UE may establish a connection and enter a state where data communication can be performed.

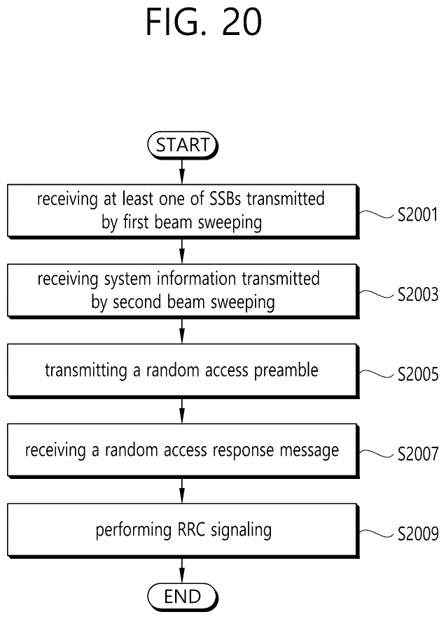

FIG. 20 shows an example of a procedure for performing an initial connection according to one embodiment of the present disclosure. FIG. 20 exemplifies an operation method of a base station.

In step S2001, a UE receives at least one of the SSBs transmitted by a first beam sweep. The SSBs are transmitted by first beam sweeping at a base station, wherein the first beam sweeping is performed using beams that are simultaneously formed towards a plurality of coverage groups. By receiving the SSB, the UE may obtain the synchronization for the base station, perform measurements, and obtain the MIB. The MIB may include information necessary to receive subsequently received system information.

In step S2003, the UE receives the system information transmitted by a second beam sweep. The UE may receive and decode the system information based on information included in the received SIB. The system information may include an SIB, and the SIB may include information related to the RACH resource. The system information is transmitted by second beam sweeping at the base station, wherein the second beam sweeping is performed using beams that are simultaneously formed toward the plurality of coverage groups. By receiving the system information, the UE may obtain the necessary information (e.g., information related to the RACH channel) to perform the initial access procedure. Along with the system information, reference signals for channel estimation may be received. In this case, the UE may estimate the channel using the reference signals. In this case, the channel information estimated by using the SSBs received in step S2001 and the channel information estimated by using the reference signals received in step S2003 may be related to different antenna subarray sets, and the UE may obtain MIMO channel information corresponding to an antenna aperture of a size formed by the antenna subarray sets by using the channel information related to the different antenna subarray sets.

In step S2005, the UE transmits a random access preamble. The UE may transmit a random access preamble transmitted from one of the RACH occasions included in the RACH resource indicated by the system information. The random access preamble includes one of a predefined sequence. Using the time-frequency location of the RACH occasion in which the random access preamble is detected, the UE may inform the base station of the SSB transmitted through the preferred transmission beam. According to one embodiment, the random access preamble may include information related to the channel estimated by using the reference signals received along with the SSB and system information. In other words, the random access preamble may include MIMO channel information estimated by the UE.

In step S2007, the UE receives the RAR message. The UE may receive the RAR message based on information related to the transmitted RACH preamble. Specifically, the UE may detect the DCI by using an RNTI determined based on at least one of a symbol index, a slot index, and a frequency axis index to which the RACH preamble is mapped, and then receive the RAR message via a resource indicated by the DCI. The RAR message may include at least one of information related to a transmit timing of the UE, information related to a resource allocated for transmitting the MSG3, and identification information allocated to the UE.

In step S2009, the UE performs RRC signaling. The UE may perform signaling to establish a connection with the base station. Specifically, the UE may receive a message for contention resolution and transmit a message requesting to establish a connection. Accordingly, the base station and the UE may establish a connection and enter a state where data communication can be performed.

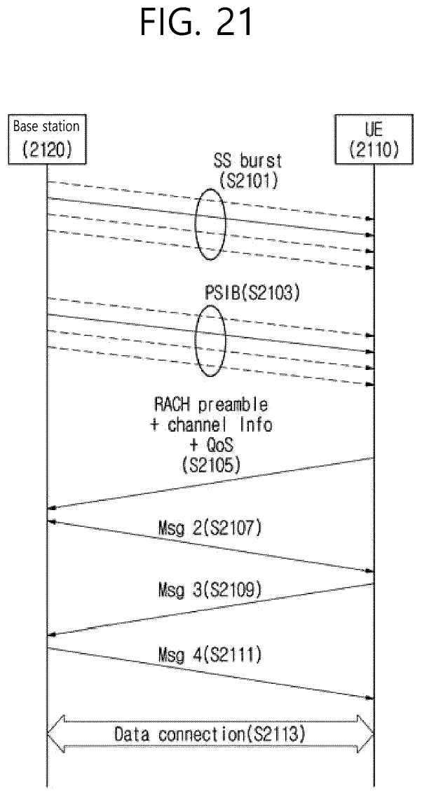

FIG. 21 shows an example of an initial connection procedure according to one embodiment of the present disclosure. FIG. 21 shows an example of a signal exchange between a UE 2110 and a base station 2120.

Referring to FIG. 21, in step S2101, a base station 2120 transmits at least one SS burst. One SS burst includes a plurality of SSBs, and the plurality of SSBs included in one SS burst may be transmitted by using beams in different directions. In other words, the base station 2120 may transmit SSBs by beam sweeping. According to one embodiment, the beam sweeping is group-based beam sweeping, and is performed for each of the groups formed considering the characteristics of the Fresnel zone channel, and the beams for coverage within the same group are formed using the same subarray set. Further, beam sweeping may be performed for a plurality of groups simultaneously, which may reduce the time required for initial access.

In step S2103, the base station 2120 transmits a PSIB. At this time, the base station 2120 may transmit the PSIB repeatedly by using beams in different directions. According to one embodiment, the beam sweeping is group-based beam sweeping, and is performed for each of the groups formed considering the characteristics of the Fresnel zone channel, and the beams for coverage within the same group are formed by using the same subarray set. Additionally, beam sweeping may be performed for a plurality of groups simultaneously. By beam sweeping, the probability of successful reception of the SIB by the UE in a narrow beam environment may be significantly increased. Here, the subarray set used to transmit PSIBs may be different from the subarray set used to transmit SSBs. Since different subarray sets are used for beam sweeping for SS bursts and PSIBs, MIMO channel estimation becomes possible.

In step S2105, the UE 2110 transmits a RACH preamble. At this time, the UE 2110 may transmit the RACH preamble through a RACH occasion selected based on the measurement results for SSB. Accordingly, the base station 2120 may detect the RACH preamble and determine which SSB the UE 2110 prefers, i.e., which transmission beam, based on the RACH occasion in which the RACH preamble is detected. In addition, the UE 2110 may further transmit at least one of channel information or quality of service (QoS) information. According to one embodiment, the UE 2110 may feedback the at least one of the estimated channel information or QoS information via a RACH preamble. Here, the channel information may include MIMO channel information estimated using the SSBs and PSIBs received in steps S2101 and S2103. The QoS information may indicate at least one of throughput, latency, bandwidth, and rate as required by the UE 2110. As a result, the base station 2120 may perform MIMO allocation during the initial access procedure based on channel feedback. As a result, data transmission may be possible immediately after completion of the initial access procedure, and delay characteristics may be improved.

In step S2107, the base station 2120 transmits MSG2. In other words, the base station 2120 transmits a RAR message. Specifically, the base station 2120 may detect the RACH preamble, generate and transmit downlink control information (DCI) by using a radio network temporary identifier (RNTI) determined based on at least one of a symbol index, a slot index, and a frequency axis index to which the detected RACH preamble is mapped, and then transmit the RAR message through a resource indicated by the DCI. The RAR message may include at least one of information related to the transmission timing of the UE 2110, information related to the resource allocated to transmit the MSG3, and identification information allocated to the UE 2110. At this point, according to one embodiment, the base station 2120 may allocate the at least one subarray to the UE 2110 based on at least one of the channel information or QoS information received from the UE 2110, and may transmit the RAR message through the allocated at least one subarray. For example, the base station 2120 may determine the number of streams, i.e., the number of subarrays, based on the QoS information, and form a beam in a preferred direction of the UE 2110 by using the determined number of subarrays. In this case, when a plurality of subarrays are allocated, the MSG2 may be transmitted in a multi-stream transmission.

In step S2109, the UE 2110 transmits the MSG3. The UE 2110 may transmit the MSG3 through a resource indicated by the RAR message. The MSG3 is transmitted through PUSCH and requests to establish a connection. For example, the MSG3 may include a connection establishment request message.

In step S2111, the base station 2120 transmits an MSG4. The MSG4 may include a contention resolution message. The UE 2110 may start a contention resolution timer after transmitting MSG3 and receive MSG4 before the timer expires. According to one embodiment, MSG4 may be transmitted over the at least one subarray allocated for transmission of MSG2.

In step S2113, the UE 2110 and the base station 2120 establish a data connection, transmit and receive data, i.e., the UE 2110 may complete the initial connection procedure and perform data communication. At this time, the base station 2120 may allocate at least one subarray for the UE 2110, and may perform MIMO transmission by using the allocated at least one subarray. In this case, the base station 2120 may allocate one or more subarrays to the UE 2110 for data communication. The one or more subarrays allocated for data communication may be different from, or at least partially overlap with, the subarrays previously used for transmitting SSB, PSIB, MSG2, MSG4, etc. Although not shown in FIG. 21, the base station 2120 may transmit configuration information for the streams allocated to the UE 2110 prior to transmitting data.

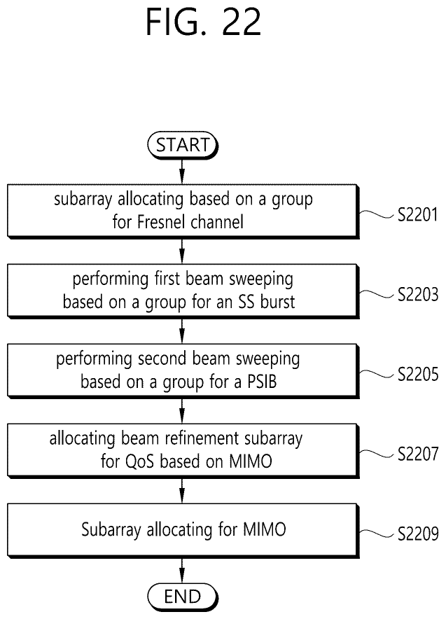

FIG. 22 shows an example of a procedure for performing beam sweeping and subarray allocation during an initial access procedure according to one embodiment of the present disclosure. FIG. 22 exemplifies an operation method of a base station.

Referring to FIG. 22, in step S2201, a base station performs a group-based subarray allocation for the Fresnel channel, that is, the base station categorizes the coverage of the plurality of beams into a plurality of groups according to the characteristics of the Fresnel zone channel, and allocates a subarray group for each group. The subarray group includes a plurality of subarray sets, and one subarray set is used to form one beam. In this case, each subarray group may include a subarray set for SS burst transmission (hereinafter referred to as an “SSB subarray set”) and a subarray set for PSIB transmission (hereinafter referred to as a “PSIB subarray set”).

In step S2203, the base station performs group-based first beam sweeping for SS bursts, i.e., the base station may transmit at least one SS burst for each group by using the SSB subarrays allocated to each group. In this case, the base station may perform beam sweeping for a plurality of coverage groups simultaneously. In other words, the base station may transmit SSBs via beams directed to a plurality of groups during a single transmission occasion.

In step S2205, the base station performs group-based second beam sweeping for the PSIBs, i.e., the base station may transmit PSIBs for each group by using the PSIB subarrays allocated to each group. In this case, the base station may perform beam sweeping for a plurality of coverage groups simultaneously. In other words, the base station may transmit PSIBs via beams directed to a plurality of groups during a single transmission occasion.

In step S2207, the base station allocates subarrays for MIMO transmission based on QoS. The operation in this step may be referred to as beam refinement. The base station may allocate the at least one subarray after receiving at least one of channel information or QoS information from the UE. Specifically, the base station may determine the number of streams, i.e., the number of subarrays, based on the QoS information and allocate the determined number of subarrays. The allocated at least one subarray may be used to transmit the at least one message (e.g., at least one of MSG2, MSG4) for the initial access. According to one embodiment, at least one of the channel information or QoS information may be received via a RACH preamble.

In step S2209, the base station allocates a subarray for MIMO, i.e., the base station may allocate at least one subarray for MIMO communication. Accordingly, the base station may perform MIMO communication by using the allocated at least one subarray. In one embodiment, the base station may consider all subarrays of the antenna as candidates. In other words, the base station may allocate at least one of the other subrays for data communication with the UE, in addition to the at least one subray previously used for the initial access procedure. Specifically, the base station determines the number of streams to be allocated based on the UE's QoS requirements and allocates the determined number of subarrays. According to the distance from the UE, the base station may determine the size of the antenna aperture, i.e., the spacing between the allocated subarrays. Once the number and spacing are determined, the base station may allocate the determined number of subarrays within the range of the determined spacing according to a predefined distribution. For example, the subarrays may be selected in a uniform distribution.

In the embodiment described with reference to FIG. 22, the base station allocates subarrays firstly for the rest operations of the initial access procedure after receiving the random access preamble, and secondly for data communication after completion of the initial access procedure. That is, for a single UE, a subarray set for SSB and PSIB transmissions, a subarray set for MSG2 and MSG3 transmissions, and a subarray set for data transmissions may be used sequentially. However, in other embodiments, the set of subarrays for MSG2 and MSG3 transmissions and the set of subarrays for data transmissions may be selected equally. In this case, the operation of secondarily allocating subarrays for data communication after completion of the initial connection procedure may be omitted. According to another embodiment, the subarray set for SSB and PSIB transmissions and the subarray set for MSG2/MSG3 transmissions may be selected identically. In this case, the operation of firstly assigning the subarrays for the rest of the operation of the initial access procedure after receiving the preamble may be omitted.

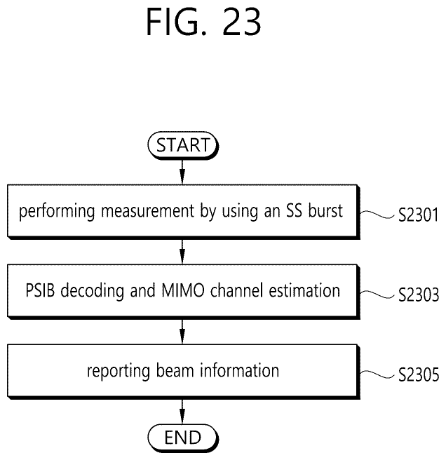

FIG. 23 shows an example of a procedure for reporting beam information during an initial access procedure according to one embodiment of the present disclosure. FIG. 23 exemplifies an operation method of a UE.

Referring to FIG. 23, in step S2301, the UE performs a measurement by using an SS burst. The UE performs measurements for at least one of a synchronization signal (e.g., PSS, SSS) included in the SS burst or a reference signal included in the PBCH. By doing so, the UE may obtain a channel quality value (e.g., RSRP) per SSB index. At this time, the UE may perform reception beam sweeping and identify the optimal beam pair. Further, the UE may obtain the master information block (MIB) that is included in the SS burst.

In step S2303, the UE decodes the PSIB and estimates the MIMO channel. The PSIB includes system information and also includes a pilot. Here, the system information may include allocation information for RACH resources, i.e., RACH channels. By using the pilot included in the PSIB and the synchronization signal or reference signal included in the SSB, the UE may estimate the MIMO channel.

In step S2305, the UE reports the beam information, i.e., the UE may transmit information related to the estimated channel to the base station. According to one embodiment, the UE may report the beam information via a RACH preamble. Based on the allocation information for the RACH channel included in the PSIB, the UE may identify a time-frequency region of the RACH channel and transmit the RACH preamble through at least one RACH occasion of the plurality of RACH occasions included in the identified time-frequency region.

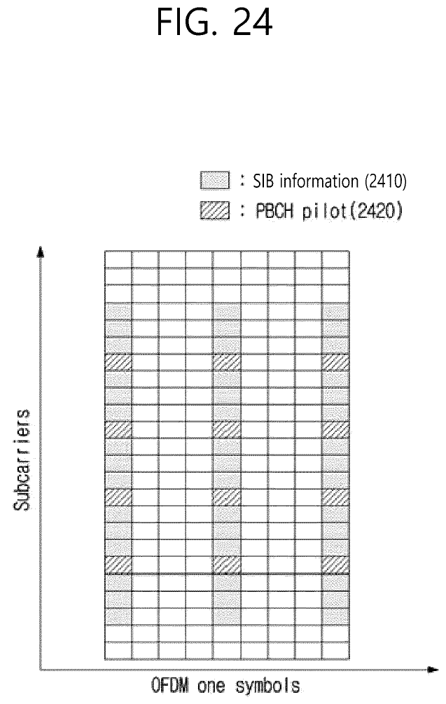

FIG. 24 shows an example of a mapping structure of system information and pilots according to one embodiment of the present disclosure. FIG. 24 shows an example structure of system information and pilots transmitted by beam sweeping, i.e., PSIB. Referring to FIG. 24, PSIB has a structure that includes SIB information 2410 and a pilot 2420 for channel estimation. As shown in FIG. 24, the channel estimation is enabled by the SIB being included in the PBCH 2410 and the PBCH pilot 2420 being configured. In FIG. 24, the SIB information 2410 and the PBCH pilot 2410 are mapped to the same symbol, but a PSIB may be defined with various other forms of structure that differ from FIG. 24.

In the aforementioned embodiments, the RACH preamble may include channel information or QoS information. A RACH preamble that includes channel information or QoS information may have the following structure. The RACH preamble includes a sequence generated based on a predefined rule, and the sequence may be cyclic shifted. According to one embodiment, at least one of the channel information or the QoS information may be represented by at least one of parameters related to the sequence or the cyclic shift. Specifically, at least one of the channel information or the QoS information may be added as shown in Equation 1 below.

$${x}_{u , v} ( n ) = {x}_{u} ( {I}_{ch , QoS} ( n + {C}_{v} ) ) mod {L}_{RA} \qquad [ Equation 1 ]$$

In [Equation 1],

$${x}_{u , ν} ( n )$$

may refer to nth element value of a cyclic shifted sequence,

$${x}_{u} ( n )$$

may refer to nth element value of a sequence before the cyclic shift, n may refer to an element index,

$${I}_{c h , Q o S}$$

may refer to information indicating at least one among channel information or QoS information,

$${C}_{ν}$$

may refer to the cyclic shift size,

$${L}_{R A}$$

may refer to the sequence length.

As in [Equation 1], according to an embodiment, at least one of channel information or QoS information may be included in a RACH preamble by

$${I}_{c h , Q o S} .$$

According to another embodiment, at least one of channel information or QoS information may be included in a RACH preamble by using one among candidate values of not

$${I}_{ch , QoQ} , but {C}_{v} .$$

According to the various embodiments described above, SS bursts are transmitted per coverage group, and SSBs may be specified by a combination of a group index and a beam index. Accordingly, an SS burst or SSB may include an index of the corresponding group. The SSB index may be indicated by information included in the SIB. For example, an SSB index may be indicated by a bit mapping of InOneGroup and groupPresence of the SSB-positionsInBurst in the ServingCellConfigCommonSIB included in the SIB. According to one embodiment, the group index may include as shown in Table 3 below.

TABLE 3
ServingCellConfigCommonSIB ::= SEQUENCE {
downlinkConfigCommon DownlinkConfigCommonSIB,
uplinkConfigCommon UplinkConfigCommonSIB OPTIONAL, -- Need R
supplementary Uplink UplinkConfigCommonSIB OPTIONAL, -- Need R
n-TimingAdvanceOffset ENUMERATED { n0, n25560, n39936 } OPTIONAL, -- Need S
ssb-Positions InBurst SEQUENCE {
inOneGroup BIT STRING,
groupPresence BIT STRING },
ssb-SSB-Beamgroup-positionsInBurst SEQUENCE {
inOneGroup BIT STRING,
groupPresence BIT STRING },
ssb-Periodicity ServingCell ENUMERATED {ms5, ms10, ms20, ms40, ms80, ms160},
tdd-UL-DL-ConfigurationCommon TDD-UL-DL-ConfigCommon OPTIONAL, -- Cond
TDD
ss-PBCH-BlockPower INTEGER (−60 .. 50),

As described above, the present disclosure proposes a beam management technique based on 3D beamforming, which is essential in the 6G THz band. A stable 3D fine beamforming-based initial access procedure may be supported by beam sweeping for PSIBs. The latency characteristics for beam sweeping in the initial access procedure may be improved by allocating subarray groups that transmit SS bursts and PSIBs. In addition, the pilot overhead and delay for MIMO allocation may be improved by incorporating the MIMO allocation procedure into the initial access procedure.

The above-described proposal methods may be implemented independently, but may also be implemented as a combination (or merging) of some of the proposal methods. The rules may be defined such that the base station informs the UE via a predefined signal (e.g., physical layer signal or higher layer signal) whether any of the above proposed methods are applied (or information for the rules of the above proposed methods).

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It will be obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

Embodiments of the present disclosure may be applied to various wireless access systems. Examples of various wireless access systems include, for example, 3rd Generation Partnership Project (3GPP) or 3GPP2 systems, etc.

Embodiments of the present disclosure may be applied not only to the various wireless access systems described above, but also to any technology field in which the various wireless access systems are applied. Further, the proposed methods may also be applied to mmWave, THz communication systems using ultra-high frequency bands.

Additionally, embodiments of the disclosure may be applied to various other applications, such as autonomous vehicles, drones, and the like.

1. A method comprising:
receiving at least one synchronization signal block (SSB) among SSBs transmitted by a base station;
receiving, system information transmitted by the base station;
transmitting a random access preamble based on the system information;
receiving a random access response (RAR) message based on information related to the random access preamble;
performing signaling for establishing a radio resource control (RRC) connection,
wherein the random access preamble includes information related to a channel estimated by using reference signals received along with the SSB and the system information.

2. The method of claim 1, wherein the information related to the channel includes multiple input multiple output (MIMO) channel information corresponding to an antenna aperture of a size formed by a first antenna subarray set used to transmit the SSB and a second antenna subarray used to transmit the system information.

3. The method of claim 1, wherein the information related to the channel is represented by using a parameter related to a cyclic shift of a sequence included in the random access preamble.

4. The method of claim 1, wherein the system information includes information related to a coverage group to which a user equipment (UE) belongs.

5. The method of claim 1, wherein the SSBs and the system information are transmitted by beam sweeping for coverage groups determined by classifying beam coverages of the base station,
wherein the coverage groups are determined based on a distance with a base station.

6. A method comprising:
transmitting synchronization signal blocks (SSBs) using a plurality of spatial domain filters;
transmitting system information;
receiving, from a user equipment (UE), a random access preamble;
transmitting a random access response (RAR) message based on information related to the random access preamble;
performing signaling for establishing a radio resource control (RRC) connection,
wherein the random access preamble includes information related to a channel estimated by using reference signals transmitted along with at least one SSB among the SSBs and the system information.

7. The method of claim 6, wherein a step of transmitting the SSBs includes:
transmitting the SSBs by beam sweeping for a first coverage group; and
transmitting the SSBs by beam sweeping for a second coverage group,
wherein the beam sweeping for the first coverage group and the beam sweeping for the second coverage group are performed during at least partially overlapping transmission occasions.

8. The method of claim 6, wherein a step of transmitting the system information includes:
transmitting the system information by using spatial domain filters different from each other, by beam sweeping for a first coverage group; and
transmitting the system information by using spatial domain filters different from each other, by beam sweeping for a second coverage group,
wherein the beam sweeping for the first coverage group and the beam sweeping for the second coverage group are performed during at least partially overlapping transmission occasions.

9. The method of claim 6, wherein the SSBs are transmitted by using a first subarray set of an antenna,
wherein the system information is transmitted by using a second subarray set of the antenna,
wherein a relative position relationship of the first subarray set and the second subarray set determines a size of an antenna aperture for a corresponding coverage group.

10. The method of claim 9, wherein an interval between the first subarray set and the second subarray set is determined based on a distance between a base station and the corresponding coverage group.

11. The method of claim 6, wherein the RAR message is transmitted through a number of subarrays, where the number is determined based on QoS (quality of service) information received through the random access preamble.

12. The method of claim 6, further comprising:
determining channel information for subarrays included in an antenna of a base station based on channel information received through the random access preamble;
allocating subarrays for data communication based on the channel information; and
transmitting data by using the subarrays for the data communication.

13. A user equipment (UE) comprising:
a transceiver; and
a processor connected to the transceiver,
wherein the processor causes the UE to:
receive at least one synchronization signal block (SSB) among SSBs transmitted by a base station;
receive, system information transmitted by the base station;
transmit a random access preamble based on the system information;
receive a random access response (RAR) message based on information related to the random access preamble;
perform signaling for establishing a radio resource control (RRC) connection,
wherein the random access preamble includes information related to a channel estimated by using reference signals received along with the SSB and the system information.

14-16. (canceled)
